(19) United States
(12) Patent Application Publication
(10) Pub. No.: US 2026/0086940 A1
(43) Pub. Date: Mar. 26, 2026

(54) Memory Sub-System with Computer Express Link Connection to Access Random Access Memory Cells Connected via Computer Express Link Fabric in Implementing Storage Services

(71) Applicant: Micron Technology, Inc., Boise, ID (US)

(72) Inventors: Kamil Khan, Folsom, CA (US); Saideep Tiku, Folsom, CA (US); Poorna Kale, Folsom, CA (US)

(21) Appl. No.: 18/896,440

(22) Filed: Sep. 25, 2024

(51) Int. Cl. G06F 3/06

(52) U.S. Cl. CPC G06F 12/08; G06F 2212/254; G06F 2212/7201

(57) ABSTRACT

A memory sub-system, having: a host interface configured to operate on a computer express link connection; non-volatile memory cells configured to provide a persistent storage space addressable over the host interface via logical block addressing addresses; and at least one processing device. The memory sub-system can: retrieve a storage access request via the host interface and over the computer express link connection to a computer express link fabric; allocate a portion of random access memory cells connected to the memory sub-system via the computer express link fabric; send, via the host interface and over the computer express link connection, one or more memory access requests into the computer express link fabric to access the portion of the random access memory cells; and process the storage access request based on one or more responses to the one or more memory access requests.

### TECHNICAL FIELD

At least some embodiments disclosed herein relate to memory systems in general, and more particularly, but not limited to host memory buffer for logical to physical translation.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The embodiments are illustrated by way of example and not limitation in the figures of the accompanying drawings in which like references indicate similar elements.

FIG. 1 illustrates an example computing system having a host system and a memory sub-system configured in accordance with some embodiments of the present disclosure.

FIG. 2 to FIG. 4 show techniques to provide a host memory buffer to a memory sub-system according to some embodiments.

FIG. 5 and FIG. 6 show dynamic mapping of host memory buffers to memory devices on a computer express link (CXL) fabric according to one embodiment.

FIG. 7 shows a technique to access a memory sub-system using a memory space provided via a computer express link fabric according to one embodiment.

FIG. 8 illustrates execution of a storage access command according to one embodiment.

FIG. 9 illustrates a controller of a computer express link (CXL) fabric caching portions of memory sub-systems in the memory space provided by memory devices connected to the fabric according to one embodiment.

FIG. 10 illustrates communications to implement a memory access request according to one embodiment.

FIG. 11 to FIG. 13 show methods to provide memory access to a storage space of a memory sub-system according to some embodiments.

FIG. 14 shows a method to implement a disaggregated host memory buffer via random access memory connected via a computer express link fabric according to one embodiment.

FIG. 15 shows a method to implement storage services via a memory sub-system having a computer express link connection to access random access memory cells connected via a computer express link fabric according to one embodiment.

FIG. 16 shows a method to provide unified memory and storage services over computer express link fabric according to one embodiment.

FIG. 17 is a block diagram of an example computer system in which embodiments of the present disclosure can operate.

### DETAILED DESCRIPTION

At least some aspects of the present disclosure are directed to the provision of host memory buffers to memory sub-systems (e.g., solid-state drives (SSDs)) via computer express links (CXLs).

A typical solid-state drive (SSD) is configured to use a non-volatile memory (e.g., NAND memory) as its persistent storage medium. Locations in the persistent storage medium can be identified or addressed by a host system using logical block addressing (LBA) addresses. A flash translation layer of the solid-state drive can translate the LBA addresses, used by a host system in identifying locations in the persistent storage medium, into internal physical addresses of corresponding locations in the non-volatile memory to perform operations of retrieving data and storing data. Such address translation operations are typically performed using a logical to physical translation table.

Such a solid-state drive (SSD) is typically configured to use a portion of its persistent storage medium (e.g., NAND memory) for persistent storage of the logical to physical translation table as part of metadata. In addition to the relatively slow persistent storage medium, the solid-state drive can have an amount of fast random access memory (e.g., dynamic random access memory (DRAM) or static random access memory (SRAM)). The fast random access memory can be used to temporarily store data used in computations performed for various operations of the solid-state drive, such as address translations. For example, an actively used portion of the logical to physical translation table can be loaded into the random access memory for caching or buffering, such that the address translations performed using the active portion can be accelerated.

However, the amount of random access memory configured in a solid-state drive (SSD) is typically insufficient to hold the entire logical to physical translation table. When the storage capacities of solid-state drives increase, the sizes of their logical to physical translation tables also increase.

A host memory buffer (HMB) is a buffer allocated to a storage device (e.g., solid-state drive (SSD)) from the memory of the host system. When a host memory buffer is allocated to a solid-state drive, the solid-state drive can buffer at least a portion of its logical to physical translation table externally in the host memory buffer to improve its performance. Accessing the external host memory buffer can be faster than accessing the internal persistent storage medium (e.g., NAND memory).

However, a typical host system has a limited amount of main memory connected to its memory bus (e.g., a double data rate (DDR) bus). To scale up the storage capacity of the computing system, many solid-state drives can be attached to a host system. However, allocating host memory buffers from the main memory to the many solid-state drives can degrade the performance of the host system.

At least some aspects of the present disclosure address the above and other deficiencies and challenges by providing host memory buffers via a computer express link (CXL) fabric.

A computer express link (CXL) fabric can have one or more CXL switches connecting a plurality of point to point CXL connections. A set of memory devices can be connected to the CXL fabric to provide a unified address space of random access memory. Memory addresses in the unified address space can be mapped to the random access memory cells in the memory devices. Requests to access memory addresses in the unified address space can propagate through the CXL fabric to the mapped random access memory cells in the memory devices connected to the CXL fabric. The random access memory implemented via the CXL fabric and the memory devices as a whole can be accessed, with cache coherence, by multiple hosts or computing devices (e.g., a central processing unit (CPU), a graphics processing unit (GPU), an artificial intelligence (AI) accelerator). The capacity of the random access memory can increase via connecting more memory devices to the CXL fabric.

A portion of the random access memory, provided via the CXL fabric and its connected memory devices as a whole, can be allocated as host buffer memories to memory sub-systems (e.g., solid-state drives). Thus, the main memory connected to a processing device (e.g., central processing unit (CPU) or system on a chip (SoC)) via a memory bus (e.g., double data rate (DDR) bus) can be reserved for the processing device for improved system performance, as further discussed below.

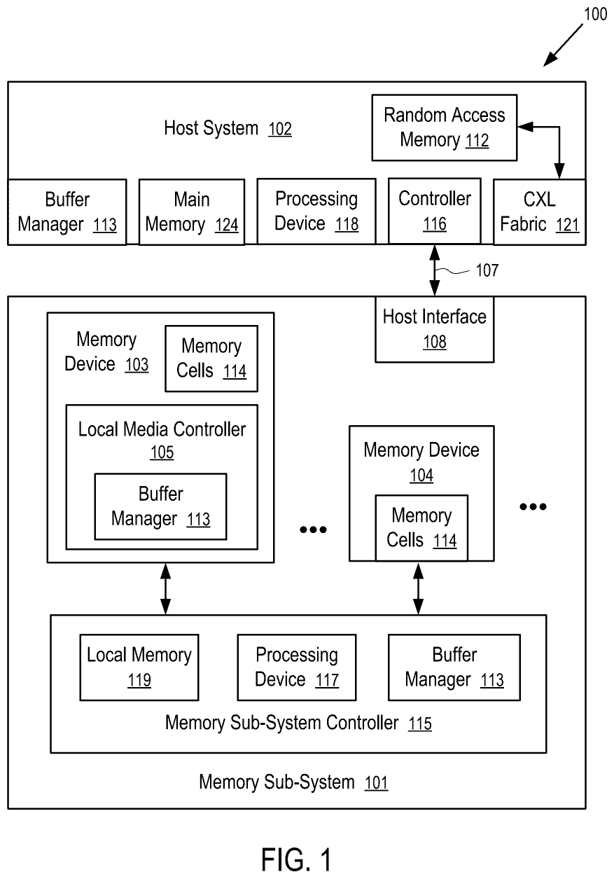

FIG. 1 illustrates an example computing system 100 that includes a memory sub-system 101 in accordance with some embodiments of the present disclosure. The memory sub-system 101 can include media, such as one or more volatile memory devices (e.g., memory device 104), one or more non-volatile memory devices (e.g., memory device 103), or a combination of such.

In general, a memory sub-system 101 can be a storage device, a memory module, or a hybrid of a storage device and memory module. Examples of a storage device include a solid-state drive (SSD), a flash drive, a universal serial bus (USB) flash drive, an embedded multi-media controller (eMMC) drive, a universal flash storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, a laptop computer, a network server, a mobile device, a vehicle (e.g., airplane, drone, train, automobile, or other conveyance), an internet of things (IoT) enabled device, an embedded computer (e.g., one included in a vehicle, industrial equipment, or a networked commercial device), or such a computing device that includes memory and a processing device.

The computing system 100 can include a host system 102 that is coupled to one or more memory sub-systems 101. FIG. 1 illustrates one example of a host system 102 coupled to one memory sub-system 101. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

For example, the host system 102 can include a processor chipset (e.g., processing device 118) and a software stack executed by the processor chipset. The processor chipset can include one or more cores, one or more caches, a memory controller (e.g., controller 116) (e.g., NVDIMM controller), and a storage protocol controller (e.g., PCIe controller, SATA controller). The host system 102 uses the memory sub-system 101, for example, to write data to the memory sub-system 101 and read data from the memory sub-system 101.

The host system 102 can be coupled (e.g., over a computer bus 107) to the memory sub-system 101 via a physical host interface 108. Examples of a physical host interface 108 include, but are not limited to, a serial advanced technology attachment (SATA) interface, a peripheral component interconnect express (PCIe) interface, a universal serial bus (USB) interface, a fibre channel, a serial attached SCSI (SAS) interface, a double data rate (DDR) memory bus interface, a small computer system interface (SCSI), a dual in-line memory module (DIMM) interface (e.g., DIMM socket interface that supports double data rate (DDR)), an open NAND flash interface (ONFI), a double data rate (DDR) interface, a low power double data rate (LPDDR) interface, a compute express link (CXL) interface, or any other interface. The physical host interface 108 can be used to transmit data between the host system 102 and the memory sub-system 101. The host system 102 can further utilize an NVM express (NVMe) interface to access components (e.g., memory devices 103) when the memory sub-system 101 is coupled with the host system 102 by the PCIe interface. The physical host interface 108 can provide an interface for passing control, address, data, and other signals between the memory sub-system 101 and the host system 102. FIG. 1 illustrates a memory sub-system 101 as an example. In general, the host system 102 can access multiple memory sub-systems via a same communication connection, multiple separate communication connections, and/or a combination of communication connections.

The processing device 118 of the host system 102 can be, for example, a microprocessor, a central processing unit (CPU), a processing core of a processor, an execution unit, etc. In some instances, the controller 116 can be referred to as a memory controller, a memory management unit, and/or an initiator. In one example, the controller 116 controls the communications over a bus coupled between the host system 102 and the memory sub-system 101. In general, the controller 116 can send commands or requests to the memory sub-system 101 for desired access to memory devices 103, 104. The controller 116 can further include interface circuitry to communicate with the memory sub-system 101. The interface circuitry can convert responses received from the memory sub-system 101 into information for the host system 102.

The controller 116 of the host system 102 can communicate with the controller 115 of the memory sub-system 101 to perform operations such as reading data, writing data, or erasing data at the memory devices 103, 104 and other such operations. In some instances, the controller 116 is integrated within the same package of the processing device 118. In other instances, the controller 116 is separate from the package of the processing device 118. The controller 116 and/or the processing device 118 can include hardware such as one or more integrated circuits (ICs) and/or discrete components, a buffer memory, a cache memory, or a combination thereof. The controller 116 and/or the processing device 118 can be a microcontroller, special purpose logic circuitry (e.g., a field programmable gate array (FPGA), an application specific integrated circuit (ASIC), etc.), or another suitable processor.

The memory devices 103, 104 can include any combination of the different types of non-volatile memory components and/or volatile memory components. The volatile memory devices (e.g., memory device 104) can be, but are not limited to, random access memory (RAM), such as dynamic random access memory (DRAM) and synchronous dynamic random access memory (SDRAM).

Some examples of non-volatile memory components include a negative-and (or, NOT AND) (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 103 can include one or more arrays of memory cells 114. One type of memory cells, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 103 can include one or more arrays of memory cells such as SLCs, MLCs, TLCs, QLCs, PLCs, or any combination of such. In some embodiments, a particular memory device can include an SLC portion, an MLC portion, a TLC portion, a QLC portion, and/or a PLC portion of memory cells. The memory cells 114 of the memory devices 103 can be grouped as pages that can refer to a logical unit of the memory device used to store data. With some types of memory (e.g., NAND), pages can be grouped to form blocks.

Although non-volatile memory devices such as 3D cross-point type and NAND type memory (e.g., 2D NAND, 3D NAND) are described, the memory device 103 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), spin transfer torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

A memory sub-system controller 115 (or controller 115 for simplicity) can communicate with the memory devices 103 to perform operations such as reading data, writing data, or erasing data at the memory devices 103 and other such operations (e.g., in response to commands scheduled on a command bus by controller 116). The controller 115 can include hardware such as one or more integrated circuits (ICs) and/or discrete components, a buffer memory, or a combination thereof. The hardware can include digital circuitry with dedicated (i.e., hard-coded) logic to perform the operations described herein. The controller 115 can be a microcontroller, special purpose logic circuitry (e.g., a field programmable gate array (FPGA), an application specific integrated circuit (ASIC), etc.), or another suitable processor.

The controller 115 can include a processing device 117 (processor) configured to execute instructions stored in a local memory 119. In the illustrated example, the local memory 119 of the controller 115 includes an embedded memory configured to store instructions for performing various processes, operations, logic flows, and routines that control operation of the memory sub-system 101, including handling communications between the memory sub-system 101 and the host system 102.

In some embodiments, the local memory 119 can include memory registers storing memory pointers, fetched data, etc. The local memory 119 can also include read-only memory (ROM) for storing micro-code. While the example memory sub-system 101 in FIG. 1 has been illustrated as including the controller 115, in another embodiment of the present disclosure, a memory sub-system 101 does not include a controller 115, and can instead rely upon external control (e.g., provided by an external host, or by a processor or controller separate from the memory sub-system).

In general, the controller 115 can receive commands or operations from the host system 102 and can convert the commands or operations into instructions or appropriate commands to achieve the desired access to the memory devices 103. The controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices 103. The controller 115 can further include host interface circuitry to communicate with the host system 102 via the physical host interface 108. The host interface circuitry can convert the commands received from the host system into command instructions to access the memory devices 103 as well as convert responses associated with the memory devices 103 into information for the host system 102.

The memory sub-system 101 can also include additional circuitry or components that are not illustrated. In some embodiments, the memory sub-system 101 can include a cache or buffer (e.g., DRAM) and address circuitry (e.g., a row decoder and a column decoder) that can receive an address from the controller 115 and decode the address to access the memory devices 103.

In some embodiments, the memory devices 103 include local media controllers 105 that operate in conjunction with the memory sub-system controller 115 to execute operations on one or more memory cells of the memory devices 103. An external controller (e.g., memory sub-system controller 115) can externally manage the memory device 103 (e.g., perform media management operations on the memory device 103). In some embodiments, a memory device 103 is a managed memory device, which is a raw memory device combined with a local controller (e.g., local media controller 105) for media management within the same memory device package. An example of a managed memory device is a managed NAND (MNAND) device.

The controller 115 and/or a memory device 103 can include a buffer manager 113 configured to perform operations related to the management of buffers allocated to submission queues through which commands are provided from the host system 102 to the memory sub-system 101 for execution. In some embodiments, the controller 115 in the memory sub-system 101 includes at least a portion of the buffer manager 113. In other embodiments, or in combination, the controller 116 and/or the processing device 118 in the host system 102 includes at least a portion of the buffer manager 113. For example, the controller 115, the controller 116, and/or the processing device 118 can include logic circuitry implementing the buffer manager 113. For example, the controller 115, or the processing device 118 (processor) of the host system 102, can be configured to execute instructions stored in memory for performing the operations of the buffer manager 113 described herein. In some embodiments, the buffer manager 113 is implemented in an integrated circuit chip disposed in the memory sub-system 101. In other embodiments, the buffer manager 113 can be part of firmware of the memory sub-system 101, an operating system of the host system 102, a device driver, or an application, or any combination therein.

For example, the buffer manager 113 implemented in the controller 115 and/or 105 of the memory sub-system 101 and/or the host system 102 can be configured to perform operations to allocate and manage a portion of a random access memory 112 provided as a host memory buffer (HMB) over a computer express link (CXL) fabric 121 to the memory sub-system 101, as further discussed below.

For example, the computer express link (CXL) fabric 121 can have one or more CXL switches connected to a plurality of memory devices to provide the random access memory 112. A host buffer memory allocated from the random access memory 112 to the memory sub-system can be disaggregated across the plurality of memory devices over the CXL fabric 121.

Memory devices connected to the CXL fabric 121 can provide a memory space addressable by a host (e.g., processing device 118, such as a central processing unit (CPU) or system on a chip (SoC)). Such a memory space of random access memory 112 provided via the CXL fabric 121 can have advantages in flexibility and scalability, when compared with the memory space of the main memory 124 provided over a memory bus (e.g., a double data rate (DDR) bus connected between the main memory 124 and the processing device 118).

Instead of configuring a host memory buffer (HMB) in the main memory 124, the host system 102 connected to the memory sub-system 101 can allocate (e.g., at the boot time) a portion of the random access memory 112 provided via the CXL fabric 121 to the memory sub-system 101 (e.g., a solid-state drive) as a host memory buffer (HMB). The memory sub-system 101 can use the host memory buffer (HMB) to store a logical to physical translation table used in the operations of its flash translation layer.

The computer express link (CXL) fabric 121 can be used to implement the host memory buffer (HMB) across a plurality of physical/logical memory devices over the CXL fabric 121. For example, a controller in the CXL fabric 121 can be configured to dynamically map the portion of random access memory 112, allocated by the host system 102 to implement the host memory buffer (HMB) for the memory sub-system 101, to physical memory cells in multiple memory devices connected to the CXL fabric 121. Thus, different portions of the host memory buffer (HMB) can physically reside in different memory devices connected to the computer express link (CXL) fabric 121. The controller can dynamically adjust the mapping based on traffic and usage in the fabric 121 to improve performance.

The flexibility and scalability of the random access memory 112 provided via the CXL fabric 121 can easily accommodate the growing demand for the size/capacity of host memory buffers allocated to multiple memory sub-systems that may be connected to the host system 102. When more memory sub-systems (e.g., 101) are connected to the host system 102, the host system 102 can allocate additional portions from the same random access memory 112, provided via the CXL fabric 121, to the memory sub-systems (e.g., 101) being added to improve their performance in logical to physical translations.

In some implementations, a disaggregated memory allocated from the random access memory 112 is connected to the memory sub-system 101 over the CXL fabric 121 to further support storage services of the memory sub-system 101, in addition to logical to physical address translations.

For example, the memory sub-system 101 can be connected to the CXL fabric 121 (e.g., as one of hosts of the CXL fabric 121) to access at least a portion of the random access memory 112 for its operations, such as storing a portion of the logical to physical translation table used in the operations of the flash translation layer of the memory sub-system 101. The memory sub-system 101 can use the portion of the random access memory 112 in a way similar to the use of its local memory 119, as if the portion of the random access memory were built into the memory sub-system 101. For example, the connection 107 can include a CXL connection to the CXL fabric 121. For example, the processing device 118 (e.g., a CPU, GPU, or SoC) can access both the random access memory 112 and the storage space of the memory sub-system 101 over the CXL fabric 121. Thus, host management of the memory sub-system 101 can be simplified.

For example, using a CXL protocol the memory sub-system 101 can use a portion of the random access memory 112 across a plurality of physical/logical memory devices in the operations of the memory sub-system 101. A controller in the CXL fabric 121 can be configured to dynamically map the portion of random access memory 112 used by the memory sub-system to the physical addresses in the memory devices connected to the CXL fabric 121. The controller can adjust the mapping based on traffic and usage of connections in the fabric 121 for improve performance.

Since the memory sub-system 101 can use a portion of the random access memory 112 over the fabric 121, the amount of local memory 119 built into the memory sub-system 101 for its exclusive use can be reduced. The flexibility and scalability of the random access memory 112 provided via the CXL fabric 121 allow the random access memory 112 to be shared among multiple memory sub-systems (e.g., 101) and the processing device 118 for improved utilization. As the demand for the random access memory 112 increases, more memory devices and/or CXL switches can be added to the fabric 121 to accommodate the growing demand of the computing system 100.

In some implementations, a controller of the CXL fabric 121 can be configured to use the random access memory 112 and the memory sub-system 101 to provide unified memory and storage services to the processing device 118 (e.g., a CPU, GPU, or SoC) in the host system 102 over the CXL fabric 121.

For example, a controller of the CXL fabric 121 can be configured to integrate the memory services of the memory devices providing the random access memory 112 and the storage services of the memory sub-system 101 to provide a unified memory space of random access memory that has a capacity larger than the capacity of the random access memory 112 and that has a persistent storage capability. Based on the data sizes addressed by the processing device 118, the controller of the fabric 121 can dynamically switch between directing the requests to the memory sub-system 115 and directing to the random access memory 112. Further, the controller of the fabric 121 can dynamically allocate a portion of the random access memory 112 as a cache memory for accessing an active portion of the storage space of the memory sub-system 101, such that the storage space of the memory sub-system 101 can appear to the processing device 118 as a portion of random access memory accessible via the fabric 121.

For example, the memory sub-system 101 can be configured to protect data stored in its persistent storage medium (e.g., non-volatile memory cells 114, such as NAND memory cells) using an error correction code (ECC) technique. An ECC block size (e.g., 512 bytes or larger) of the memory sub-system 101 can be significantly larger than a typical memory access size (e.g., a cache line of 128 bytes or smaller). When the processing device 118 in the host system 102 accesses data at a small chunk size and the data being accessed is in the memory sub-system 101, the controller of the fabric 121 can take the ECC decoded/corrected data and mirror it in a portion of the random access memory 112 device for subsequent access. The controller 116 can dynamically remap the address as accessed by the processing device 118 from the memory sub-system 101 to the random access memory 112 for the block. When the processing device 118 accesses data at a large chunk size, the controller can map the address back to the storage space in the memory sub-system 101, as further discussed below.

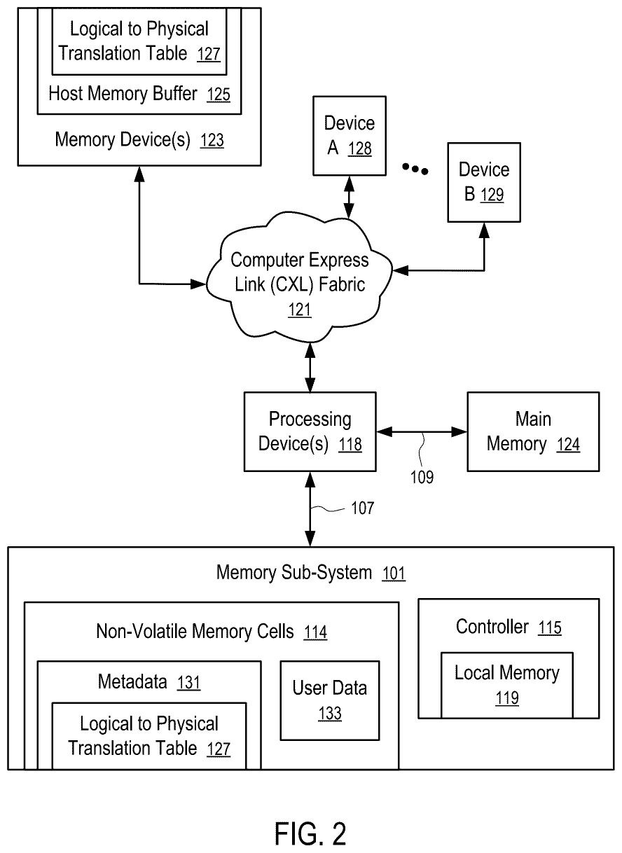

FIG. 2 to FIG. 4 show techniques to provide a host memory buffer to a memory sub-system according to some embodiments. For example, the techniques of FIG. 2 to FIG. 4 can be implemented in the computing system 100 of FIG. 1 using the random access memory 112 provided over the CXL fabric 121.

In FIG. 2 to FIG. 4, a computer express link (CXL) fabric 121 is configured to provide a unified memory space of random access memory (e.g., 112) using a set of memory devices 123 that have random access memory cells.

For example, the computer express link (CXL) fabric 121 can include a set of switches interconnected via CXL connections and controlled at least in part by a controller. The memory devices 123 are connected to the switches in the fabric 121 via point to point CXL connections; and the controller of the CXL fabric 121 is configured to direct how memory access communications are routed by the switches through the fabric 121 to the memory devices 123.

The unified memory space of random access memory (e.g., 112), implemented using the memory devices 123 connected via the fabric 121, can service multiple hosts/processing devices, such as processing device(s) 118 (e.g., central processing unit (CPU), system on a chip (SoC)), and other devices 128, . . . , 129 (e.g., artificial intelligence (AI) accelerator, graphical processing unit (GPU), network interface card).

In FIG. 2, a main memory 124 is connected to the processing device(s) 118 via a memory bus 109 (e.g., a double data rate (DDR) bus); and a memory sub-system 101 (e.g., as in FIG. 1) is connected to the processing device(s) using a peripheral bus 107 (e.g., a peripheral component interconnect express (PCIe) bus) that is different and separate from the memory bus 109.

The memory of the host system 102 as a whole can include the main memory 124 and the unified memory space of random access memory (e.g., 112) implemented using the memory devices 123 connected via the fabric 121.

In FIG. 2, instead of allocating a host memory buffer (HMB) from the main memory 124 to memory sub-system 101, a host memory buffer 125 is allocated (e.g., by a buffer manager 113) to the memory sub-system 101 from the random access memory of the memory devices 123.

For example, the memory sub-system 101 can use its non-volatile memory cells 114 (e.g., NAND memory) for persistent storage of metadata 131, such as a logical to physical translation table 127. The storage capacity of the memory cells 114 is used to store both user data 133 and the metadata 131 about the storage of the user data 133.

However, accessing the non-volatile memory cells 114 for address translation computations can be slower than accessing the host memory buffer 125 over the CXL fabric 121 and slower than accessing the local memory 119.

To improve the speed of address translation operations, the buffer manager 113 in the memory sub-system 101 can load an actively used portion of the logical to physical translation table 127 into its local memory 119, and load another portion of the logical to physical translation table 127 that is likely to be used into the host memory buffer 125. Such an arrangement can reduce the need to read and write the non-volatile memory cells 114 to use and update the logical physical translation table 127 and thus improve the overall performance of the memory sub-system 101 in providing its storage services. Optionally, the memory sub-system 101 can use a portion of the logical to physical translation table 127 in the host memory buffer 125 directly in address translation without loading the portion into the local memory 119.

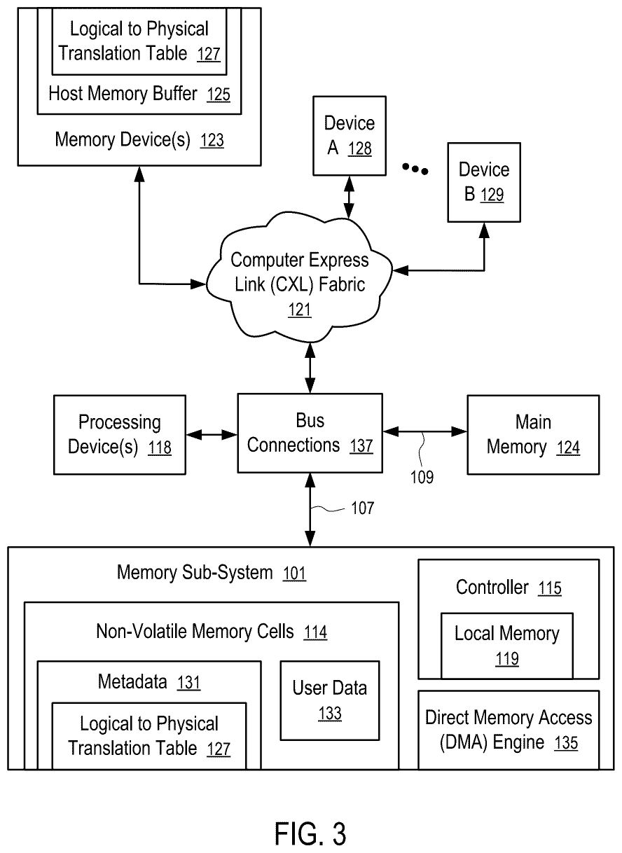

In some implementations, the memory sub-system 101 can access, over the CXL fabric 121, the host memory buffer 125 in the memory devices 123 without going through and/or without assistance from the processing devices 118 connected to the main memory 124, as in FIG. 3 In FIG. 3, a set of bus connections 137 can interconnect the peripheral bus 107 (e.g., a peripheral component interconnect express (PCIe) bus), the memory bus 109 (e.g., a double data rate (DDR) bus) and the CXL fabric 121. The memory sub-system 101 is configured with a direct memory access (DMA) engine 135 operable to access the memory in the host system 102, including the main memory 124 and the unified memory space of random access memory (e.g., 112) implemented using the memory devices 123 connected via the fabric 121.

Using the DMA engine 135 the buffer manager 113 of the memory sub-system 101 can copy a portion of the logical physical translation table 127 from the local memory 119 to the host memory buffer 125 in the memory devices 123. Thus, the local memory 119 can be freed for storing another portion of the logical to physical translation table 127 for active use, or for other memory usages.

For example, the memory sub-system 101 can retrieve a portion of the logical to physical translation table 127 from the non-volatile memory cells 114 into the local memory 119 and then copy the portion to the host memory buffer 125 (e.g., for buffering/caching, and/or for reference in address translation).

For example, the memory sub-system 101 can store a portion of the logical to physical translation table 127 in the local memory 119 for active address translation operations. When subsequent operations do not use the portion for a period of time, the memory sub-system 101 can offload the portion to the host memory buffer 125 for buffering and to load another portion of the logical to physical translation table 127 (e.g., from the host memory buffer 125, or the memory cells 114) for active use.

When a portion of the logical physical translation table 127 in the host memory buffer 125 is to be used actively, the DMA engine 135 can fetch the portion of the logical physical translation table 127 from the host memory buffer 125 into the local memory 119 without assistance from the processing device(s) 118.

In some implementations, the DMA engine 135 and/or the memory sub-system 101 can function as a host of the main memory 124 and/or the unified memory space of random access memory (e.g., 112) implemented using the memory devices 123 connected via the fabric 121. Thus, the memory sub-system 101 can configure a portion of the local memory 119 as a cache memory for accessing the unified memory space of random access memory (e.g., 112) implemented using the memory devices 123 connected to the fabric 121, including the host memory buffer 125.

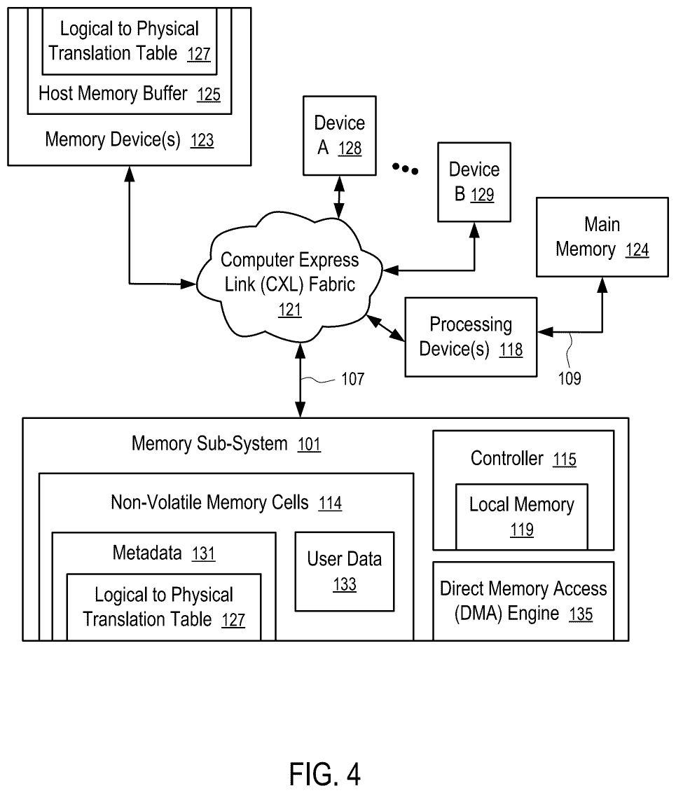

In some implementations, the connection 107 to the memory sub-system 101 is also a computer express link (CXL) connection to the fabric 121, as in FIG. 4.

When the memory sub-system 101 is connected to the fabric 121 via a computer express link (CXL) connection, the memory sub-system 101 and/or a direct memory access (DMA) engine in the memory sub-system 101 can use the unified memory space of random access memory (e.g., 112) implemented using the memory devices 123 connected via the fabric 121 in a way similar to the processing device(s) 118 using the unified memory space of random access memory (e.g., 112). The memory sub-system 101 can dynamically allocate a portion of the unified memory space as its host memory buffer 125 to store the entire logical to physical translation table 127 or a portion of it, without assistance from the processing device(s) 118 connected to the main memory 124.

In some implementations, when the memory sub-system 101 is connected to the fabric 121 via a computer express link (CXL) connection, a controller of the CXL fabric 121 can use the storage space of the non-volatile memory cells 114 to provide a logical memory device in a portion of the unified memory space of random access memory accessible by various hosts connected to the fabric 121, such as the processing device(s) 118 and other devices 128, . . . , 129 (e.g., artificial intelligence (AI) accelerator, graphical processing unit (GPU)), as further discussed below. Thus, the devices (e.g., 118, 128, 129) connected to the fabric 121 can virtually access the memory sub-system 101 over the fabric 121 as if the storage space of the memory sub-system 101 (e.g., the capacity of the non-volatile memory cells 114) were random access memory.

Different portions of the capacity of a storage device (e.g., solid-state drive) is typically configured to be addressed for access using logical block addressing (LBA) addresses. Each LBA address represents a predetermined amount of capacity (e.g., 512 bytes, 4 KB), which is significantly larger than the capacity represented by a memory address for accessing a random access memory.

Different portions of a random access memory (e.g., 124, 112) is typically configured to be addressed for access using memory addresses. Each memory address represents a predetermined amount of capacity (e.g., one byte, eight bytes, or 128 bytes), which is significantly smaller than the capacity of an LBA address for accessing a storage device.

Communication protocols for accessing via LBA addresses and for accessing via memory addresses are typically adapted differently to accommodate typical patterns of accessing: large chunks of data accessed via LBA addresses and small chunks of data accessed via memory addresses.

For example, when a large chunk of data is accessed via an LBA address, it is possible to use a relatively large amount of communication overhead to implement enhanced features without significantly degrading the system performance. In contrast, when a small chunk of data is accessed via a memory address, an increase in communication overhead can significantly degrade the system performance. Thus, block-based storage devices and random access memory devices are typically not interchangeable in their usages in a computing system.

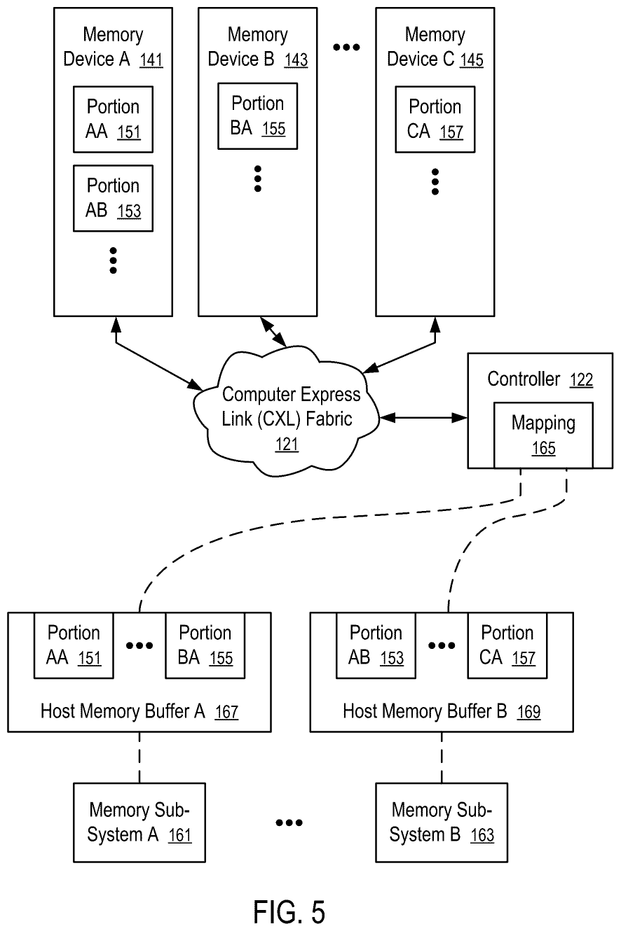

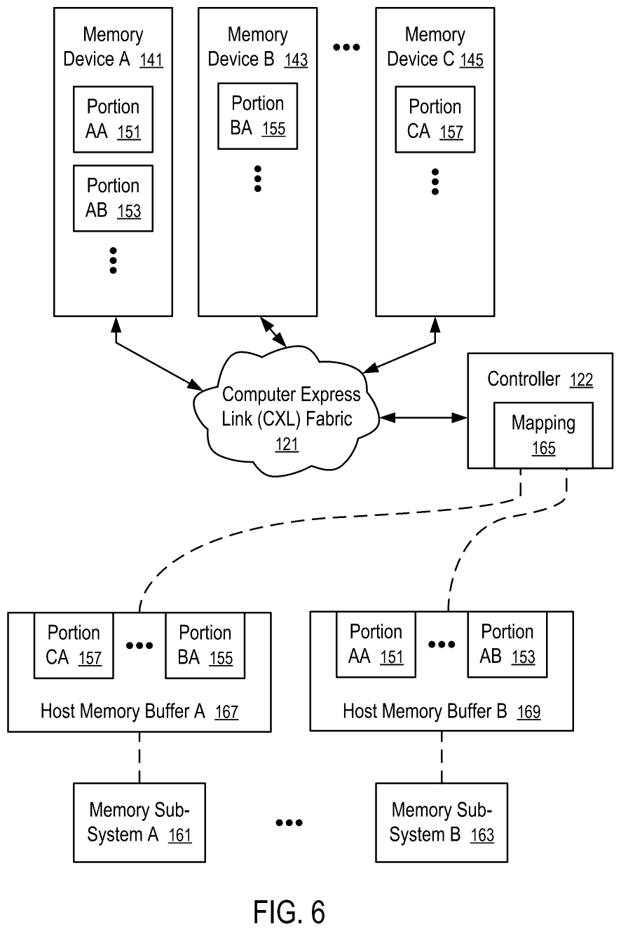

FIG. 5 and FIG. 6 show dynamic mapping of host memory buffers to memory devices on a computer express link (CXL) fabric according to one embodiment. For example, the host memory buffer 125 in FIG. 2 to FIG. 4 can be mapped dynamically in a way as illustrated in FIG. 5 and FIG. 6.

In FIG. 5 and FIG. 6, a plurality of memory devices 141, 143, . . . , 145 are connected to a computer express link (CXL) fabric 121 to provide a unified space of random access memory (e.g., 112). A controller 122 of the fabric 121 (e.g., fabric manager) is operable to dynamically map memory addresses in the unified space to physical memory addresses in portions of the memory devices 141, 143, . . . , 145.

For example, different portions of the unified space can be allocated as host memory buffers 167, . . . , 169 for different memory sub-systems 161, . . . , 163 respectively. Each of the memory sub-systems 161, . . . , 163 can have a separate host memory buffer (e.g., 167 or 169) in a way as the memory sub-system 101 having a host memory buffer 125 in FIG. 2 to FIG. 4.

In FIG. 5, the host memory buffer 167 allocated to the memory sub-system 161 is implemented, by the controller 122 via an address mapping 165, using portions of random access memories of different memory devices, such as a portion 151 of random access memory in one memory device 141, a portion 155 of random access memory in another memory device 143, etc. Thus, different portions of the host memory buffer 167 can be physically disaggregated across a plurality of memory devices (e.g., 141, 143).

Similarly, different portions of the host memory buffer 169 allocated to the memory sub-system 163 can be physically disaggregated across a plurality of memory devices (e.g., 141, 145). For example, one portion of the host memory buffer 169 is implemented by the controller 122 using a portion 153 of random access memory in one memory device 141; and another portion of the host memory buffer 169 is implemented by the controller 122 using a portion 157 of random access memory in another memory device 145.

The host memory buffers 167, . . . , 169 allocated to the different memory sub-system 161, . . . , 163 do not share a common portion from a same memory device. Thus, each portion (e.g., 151) allocated from a memory device (e.g., 141) to implement a host memory buffer (e.g., 167) is allocated for exclusive used as part of the host memory buffer (e.g., 167), not shared with another host memory buffer (e.g., 169) and not allocated for other uses.

Based on the current communication traffic in the fabric 121, the controller 122 can optionally adjust the mapping 165 to improve the performance of the system.

For example, the controller 122 can adjust the mapping 165 for the host memory buffers 167, . . . , 169 based on activities to access the memory devices 141, 143, . . . , 145 over the fabric. Such activities can include the activities of the memory sub-systems 161, . . . , 163 to access, via the fabric 121, the host memory buffers 167, . . . , 169 and thus various portions (e.g., 151, 155, 157) of the memory devices 141, 143, . . . , 145. Further, such activities relevant to the adjustment of the mapping 165 can include the activities of other devices (e.g., processing device(s) 118, devices 128, . . . , 129 illustrated in FIG. 2 to FIG. 4, such as artificial intelligence (AI) accelerator, graphical processing unit (GPU) using the random access memory provided via the fabric 121).

Different patterns of activities and different ways to allocate portions of the memory devices to the host memory buffers 167, . . . , 169 can have different impacts on traffic delays in the fabric 121. The controller 122 can decide changes in allocation of portions of the memory devices 141, 143, . . . , 145 to the host memory buffers 167, . . . , 169 to improve the performance of the host memory buffers 167, . . . , 169, and/or to improve the performance of the computing system 100 in using the memory devices 141, 143, . . . , 145.

For example, in FIG. 6, the host memory buffer 167 is implemented using the portion 157 of the memory device 145 and the portion 155 of the memory device 143; and the host memory buffer 169 is implemented using the portions 151 and 153 of the memory device 141.

In some instances, the use of the mapping as in FIG. 6 can reduce traffic jam in the fabric 121 and thus improve the system performance over the use of the mapping as in FIG. 5. Thus, the controller 122 can adjust the mapping 165 to implement the host memory buffers 167, . . . , 169 in a way as illustrated in FIG. 6, instead of implementing the host memory buffers 167, . . . , 169 in a way as illustrated in FIG. 5, based on a recent pattern of activities in the fabric 121.

The controller 122 can instruct the memory devices 141, 143, . . . , 145 to move, exchange, and/or relocate data such that the change in the mapping 165 for implementing the host memory buffers 167, . . . , 169 is shielded from the memory sub-systems 161, . . . , 163. The memory sub-system 161, . . . , 163 can use their respective host memory buffers 167, . . . , 169 without the need to be aware of how the host memory buffers 167, . . . , 169 are implemented using which portions of memory devices 141, 143, . . . , 145.

In general, the controller 122 can change the mapping 165 by changing which portions of the memory devices 141, 143, . . . , 145 are used to implement a host memory buffer (e.g., 167 or 169). Further, the size(s) of the portions allocated to implement the host memory buffer (e.g., 167 or 169) can change; and the number of portions used to implement the host memory buffer (e.g., 167 or 169) can change.

The controller 122 can make the change in the mapping 165 on the fly during the operations of the memory sub-systems 161, . . . , 163. It is not necessary for the memory sub-systems 161, . . . , 163 to stop their operations for the controller 122 to make the change; and it is not necessary for the memory sub-systems 161, . . . , 163 to restart to effectuate the change.

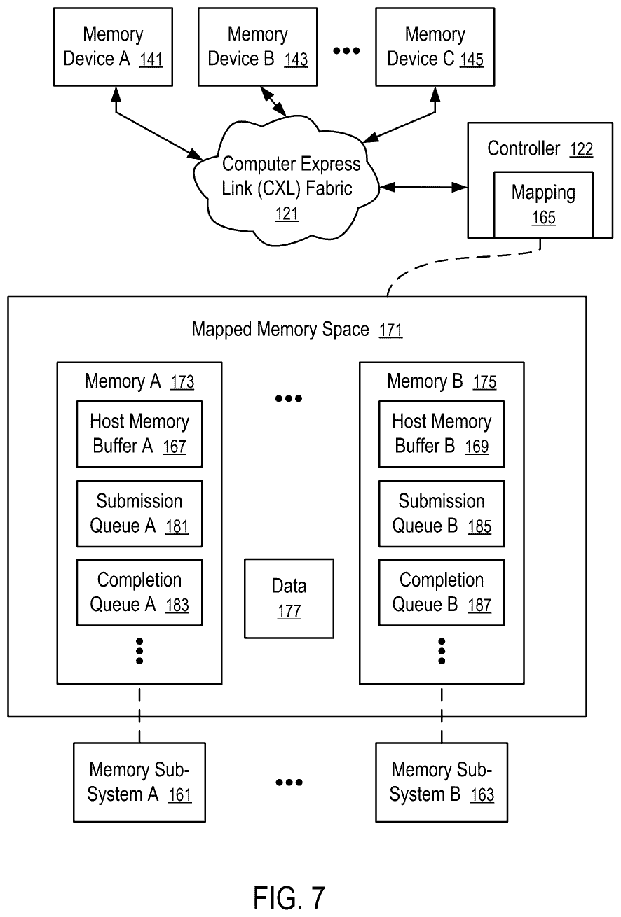

FIG. 7 shows a technique to access a memory sub-system using a memory space provided via a computer express link fabric according to one embodiment.

In FIG. 7, a unified/mapped memory space 171 is implemented via a controller 122 of a computer express link (CXL) fabric 121 connecting a plurality of memory devices 141, 143, . . . , 145 of random access memory (e.g., as in FIG. 2 to FIG. 6).

The mapped memory space 171 can have memories 173, . . . , 175 allocated respectively to memory sub-systems 161, . . . , 163.

The mapped memory space 171, implemented according to mapping 165 in the controller 122, can have different portions allocated as host memory buffers 167, . . . , 169 for different memory sub-systems 161, . . . , 163, as in FIG. 5 and FIG. 6.

Further, the portions of the mapped memory space 171 (e.g., memories 173, 175) configured for the memory sub-systems (e.g., 161, 163) can include cycle buffers for hosting submission queues (e.g., 181, 185) and completion queues (e.g., 183, 187). The queues (e.g., 181, 183, 185, 187) can be used to facilitate communications with the memory sub-systems 161, . . . , 163 for storage access (e.g., according to a non-volatile memory express (NVMe) standard).

For example, the memory 173 in the mapped memory space 171 can include a host memory buffer 167 allocated to the memory sub-system 161, a submission queue 181 for sending commands to the memory sub-system 161, and a completion queue 183 for receiving messages reporting completion of execution of the commands sent via the submission queue 181. In general, the memory 173 allocated from the mapped memory space 171 for the memory sub-system 161 can include a plurality of submission queues (e.g., 181) and a plurality of completion queues (e.g., 183).

In FIG. 7, a memory sub-system (e.g., 161) is allowed to retrieve commands from its submission queues (e.g., 181) but not allowed to retrieve commands from submission queues (e.g., 185) configured for other memory sub-systems (e.g., 163). Similarly, a memory sub-system (e.g., 161) is allowed to enter completion messages into its submission queues (e.g., 183) but not allowed to enter messages into completion queues (e.g., 185) configured for other memory sub-systems (e.g., 163).

The host system 102 can send commands (e.g., read commands, write commands) to a memory sub-system (e.g., 161, or 163) by entering the commands in a submission queue (e.g., 181 or 185) configured for the memory sub-system (e.g., 161, or 163).

For example, the processing device(s) 118 of the host system 102 can write a command into the submission queue 181 (e.g., in accordance with a NVMe standard); and the memory sub-system 161 can subsequently retrieve the command from the submission queue 181 (e.g., in accordance with the NVMe standard) for execution.

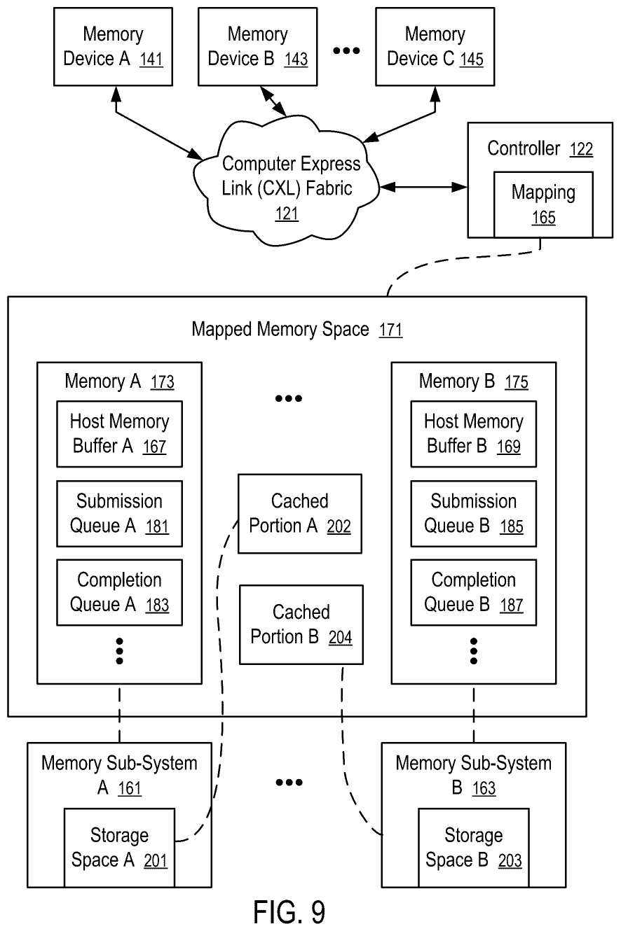

In some implementations, a submission queue (e.g., 181) in the mapped memory space 171 is reserved for the controller 122 of the computer express link fabric 121 to send commands to operate the respective memory sub-system (e.g., 161). For example, the controller 122 can use a portion of the memory space 171 to cache a portion of the memory sub-system 161 (e.g., as illustrated in FIG. 9) via sending commands to the memory sub-system (e.g., 161) via the submission queue (e.g., 181) without assistance from the processing device(s) 118. Thus, the processing device(s) 118 can access the cached portion of the memory sub-system 161 without the need to send storage access commands to the memory sub-system (e.g., 161) using a submission queue. The controller 122 can generate the storage access commands for the processing device(s) 118 in response to the memory access requests received in the fabric 121 from the processing device(s)

The host system 102 can enter a read command in the submission queue 185 configured for the memory sub-system 163. After the memory sub-system 163 retrieves the read command from the submission queue 185, the memory sub-system 163 can execute the read command to retrieve data (e.g., 177) from its storage medium (e.g., non-volatile memory cells 114) and write the data (e.g., 177) to a memory address identified in the read command. For example, the memory address can be used to identify a location in the mapped memory space 171. Alternatively, the memory address can be used to identify a location in the main memory 124. For example, a direct memory access (DMA) engine (e.g., 135 in FIG. 3 or FIG. 4) of the memory sub-system 163 can send the data (e.g., 177) to the memory address identified in the read command without assistance from the processing device(s) 118 of the host system 102.

The host system 102 can enter a write command in the submission queue 181 configured for the memory sub-system 161. After the memory sub-system 161 retrieves the write command from the submission queue 181, the memory sub-system 161 can execute the write command by retrieving data (e.g., 177) from a memory address identified in the write command and programming its storage medium (e.g., non-volatile memory cells 114) to store the data (e.g., 177). For example, the memory address can be used to identify a location in the mapped memory space 171. Alternatively, the memory address can be used to identify a location in the main memory 124. For example, a direct memory access (DMA) engine (e.g., 135 in FIG. 3 or FIG. 4) of the memory sub-system 161 can load the data (e.g., 177) from the memory address identified in the write command without assistance from the processing device(s) 118 of the host system 102.

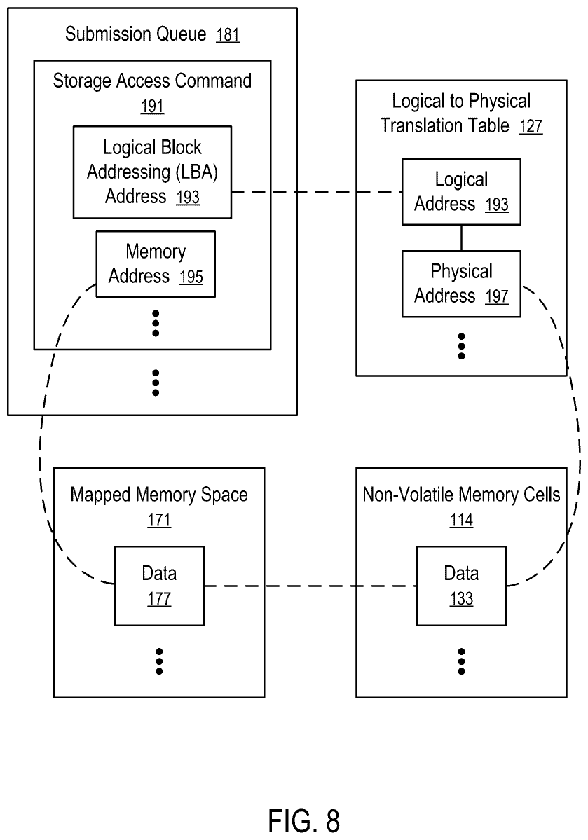

For example, the computing system 100 can be configured to execute a storage access command as illustrated in FIG. 8.

FIG. 8 illustrates execution of a storage access command according to one embodiment. For example, the commands provided in submission queues (e.g., 181 or 185) in FIG. 7 can be executed in a memory sub-system (e.g., 161 or 163) in a way as illustrated in FIG. 8.

In FIG. 8, a storage access command 191 in a submission queue 181 is configured to identify a logical block addressing (LBA) address 193 and a memory address 195.

The logical block addressing (LBA) address 193 identifies a logical location in a storage medium, such as non-volatile memory cells 114 of a memory sub-system 101 (e.g., 161 or 163 in FIG. 5 to FIG. 7).

The memory sub-system 101 has a logical to physical translation table 127 configured to map the LBA address 193 to the physical address 197 that can be used to address a set of memory cells among the non-volatile memory cells 114.

As in FIG. 2 to FIG. 7, at least a portion of the logical to physical translation table 127 can be buffered in the host memory buffer 125 (e.g., 167 or 169 for a memory sub-system 161 or 163 in FIG. 5 to FIG. 7).

In one embodiment, when the portion of the mapping between the logical address 193 and the physical address 197 is in the host memory buffer 125, the memory sub-system 101 can compute a location in the host memory buffer 125 where the physical address 197 associated with the logical address 193 is stored, and send a load command to load the physical address 197 from the host memory buffer 125 over the computer express link (CXL) fabric 121. Optionally, when the portion of the logical to physical translation table 127 is used frequently in recent operations, the buffer manager 113 can load the portion into the local memory 119 for further improved performance in address translation operations.

The memory address 195 can be configured to identify a location in the mapped memory space 171. With the memory address 195 and the physical address 197, the memory sub-system 101 can execute the storage access command 191 to transfer data for a read operation or a write operation.

For example, when the storage access command 191 includes an opcode for a read operation, the memory sub-system 101 can retrieve data 133 from the non-volatile memory cells 114, decode the data 133 using an error correction code (ECC) technique to obtain retrieved error-free data 177, and store the data 177 to the mapped memory space 171 at the memory address 195. In response to the memory sub-system 101 storing data 177 to the memory address 195, the controller 122 of the computer express link fabric 121 maps the memory address 195 in the memory space 171 to an address in a memory device (e.g., 141, 143, or 145) connected to the fabric 121, and route to the memory device (e.g., 141, 143, or 145) the request to store the data 177. Thus, the data 177 is physically stored in the memory device (e.g., 141, 143, or 145). Alternatively, the memory address 195 can be configured to identify a location in the main memory 124; and in response, the retrieved data 177 is stored to the location in the main memory 124.

For example, when the storage access command 191 includes an opcode for a write operation, the memory sub-system 101 can load data 177 from the location in the mapped memory space 171 as specified by the memory address 195, encode the data 177 using an error correction code (ECC) technique to generate data 133, allocate non-volatile memory cells 114 at the physical address 197 to store the data 133, update the logical to physical translation table 127 to map the logical block addressing address 193 to the physical address 197 of the allocated non-volatile memory cells 114, and program the allocated memory cells to have states representing the data 133. In response to the memory sub-system 101 loading data 177 from the memory address 195, the controller 122 of the computer express link (CXL) fabric 121 maps the memory address 195 in the memory space 171 to an address in a memory device (e.g., 141, 143, or 145) connected to the fabric 121, and route to the memory device (e.g., 141, 143, or 145) the request to load data 177. Alternatively, the memory address 195 can be configured to identify a location in the main memory 124; and in response, the data 177 is loaded from the location in the main memory 124.

In some implementations, portions of the storage spaces of memory sub-systems 161, . . . , 163 connected to the fabric 121 are cached in the mapped memory space 171 to accelerate access to the portions of the storage spaces of the memory sub-systems 161, . . . , 163, as illustrate in FIG. 9.

FIG. 9 illustrates a controller of a computer express link (CXL) fabric caching portions of memory sub-systems in the memory space provided by memory devices connected to the fabric according to one embodiment.

In FIG. 9, the memory sub-systems 161, . . . , 163 can be attached to a host system 102 having a computer express link (CXL) fabric 121 as in FIG. 2 to FIG. 7. Each of the memory sub-systems 161, . . . , 163 can be implemented in a way as in FIG. 1. The controller 122 of the fabric 121 can implement the mapped memory space 171 using the random access memory in the memory devices 141, 143, . . . , 145 connected to the CXL fabric 121.

For example, a memory sub-system 161 can have a storage space 201

addressable via logical block addressing (LBA) addresses (e.g., 193) as in FIG. 8 using storage access commands (e.g., 191). A portion of the storage space 201 can be cached in the mapped memory space 171 as a cached portion 202 that is physically mapped to one or more portions in the memory devices (e.g., 141, 143, and/or 145) connected to the fabric 121, in a way similar to the mapping of the host memory buffer 167 being implemented using portions of the memory devices 141, 143, . . . , 145 connected to the fabric 121.

Similarly, a storage space 203 in the memory sub-system 163 can have a portion cached as a cached portion 204 in the mapped memory space 171. The cached portion 204 can be implemented using portions of the memory devices 141, 143, . . . , 145, in a way similar to the implementation of the host memory buffer 169 allocated to the memory sub-system 163.

The processing device(s) 118 in the host system 102 can optionally access the memory sub-systems 161, . . . , 163 via entering storage access commands (e.g., 191) into the submission queues (e.g., 181, 185) configured for the memory sub-systems 161, . . . , 163, or send memory access commands to the fabric 121 using memory addresses of the cached portions (e.g., 202, 204).

Optionally, the controller 122 can be configured to present the entire storage space 201 of the memory sub-system 161 as a cached portion 202 in the mapped memory space 171 such that the processing device(s) 118 can use the storage space 201 without using storage access commands (e.g., 191) and without using submission queues (e.g., 181) configured for the memory sub-system 161. Thus, the submission queues (e.g., 181) configured for the memory sub-system 161 can be reserved for exclusive use by the controller 122 in implementing the cached portion 202. The processing device(s) 118 can access the cached portion 202 using memory access requests instead of storage access commands.

For example, the controller 122 can be configured to present (e.g., to the processing device(s) 118 and other devices 128, . . . 129 connected to the fabric 121) the entire storage space 201 of the memory sub-system 161 as a portion of a random access memory in the mapped memory space 171, as if the memory sub-system 161 were a random access memory device. For example, the storage space 201 can have a capacity larger than the combined random access memory capacity of the memory devices 141, 143, . . . , 145; and thus, the mapped memory space 171 can be larger than the combined random access memory capacity of the memory devices 141, 143, . . . , 145. The controller 122 can configure its mapping 165 to map an actively used portion of the storage space 201 as a cached portion 202 that is currently mapped to portions of the memory devices 141, 143, . . . , 145, while other portions of the storage space 201 as mapped to the memory space 171 are not concurrently implemented using the random access memory in the memory devices 141, 143, . . . , 145. The memory space 171 implemented using the storage space 201 can be actually implemented using the memory devices 141, 143, . . . , 145 one portion at time. Thus, the portion of the memory space 171 implemented using the storage space 201 can have persistent storage in the memory sub-system 161, while an actively used portion of the storage space 201 is implemented (e.g., mirror or cached) in the memory devices 141, 143, . . . , 145.

For example, when the processing device(s) 118 requests accesses to memory addresses in the mapped memory space 171 that correspond to a portion of the storage space 201, the controller 122 can determine a corresponding LBA address (e.g., 193) of the portion. If the storage space represented by the LBA address (e.g., 193) is not already cached or mirrored in the memory space 171 using random access memory of the memory devices 141, 143, . . . , 145, the controller 122 can dynamically allocate one or more portions from the memory devices 141, 143, . . . , 145, enter a read command in the submission queue 181 configured for the memory sub-system 161 to retrieve the data at the LBA address (e.g., 193) into the cached portion 202 implemented using the dynamically allocated portions of the memory devices 141, 143, . . . , 145, and route the memory access requests from the processing device(s) 118 over the fabric 121 to the memory devices 141, 143, . . . , 145.

When the controller 122 determines that the cached portion 202 is not likely to be accessed by the processing device(s) 118 in a subsequent period of time and the content of the cached portion 202 has not yet been committed into the storage space 201, the controller 122 can enter a write command in the submission queue 181 to write the data of the cached portion 202 into the memory sub-system 161. Upon receiving a completion message in the completion queue 183 that indicates the completion of the write command, the controller 122 can free the random access memory allocated from the memory devices 141, 143, . . . , 145 to implement the cached portion 202, which can then be reused to implement another cached portion of the storage space 201 of the memory sub-system 161, or a cached portion 204 of the storage space 203 of another memory sub-system 163.

Thus, the controller 122 can effectively provide a unified memory and storage service to devices (e.g., 118, 128, 129) connected to the computer express link (CXL) fabric 121 through the use of mapping 165 to route memory access requests to the memory devices 141, 143, . . . , 145 over the CXL fabric 121 and the use of the submission queues (e.g., 181, 185) and completion queues (e.g., 183, 187) to operate the memory sub-systems 161, . . . , 163. The devices (e.g., 118, 128, 129) can access the storage spaces 201, . . . , 203 of the memory sub-systems 161, . . . , 163 via the memory devices 141, 143, . . . , 145 that are dynamically mapped by the controller 122 as proxies. Since the tasks of using message queues (e.g., 181, 183, 185, 187) to communicate with memory sub-systems (e.g., 161, 163) are offloaded to the controller 122 of the CXL fabric 121, the complexity of routines and applications running in the processing devices (e.g., 118, 128, 129) can be reduced.

Optionally, the entire portion of the memory space 171 that is accessible to the host devices (e.g., 118, 128, 129) of the CXL fabric 121 is mapped to the storage spaces 201, . . . , 203 of the memory sub-systems. Thus, the random access memory provided by the fabric 121 to the host devices (e.g., 118, 128, 129) can be used as a non-volatile random access memory.

Optionally, the controller 122 can dynamically adjust the mapping 165 of which portions of the mapped memory space 171 are mapped to which of the memory sub-systems 161, . . . , 163 connected to the CXL fabric 121. The controller 122 can adjust the mapping 165 to balance the workloads on the memory sub-systems 161, . . . , 163 and thus improve the performance of the system.

The unified memory and storage services allow the host devices (e.g., 118, 128, 129) connected to the CXL fabric 121 to access the mapped memory space 171 using memory addresses (e.g., 195) and memory access requests at a granularity of random memory access (e.g., in a unit of one byte, eight bytes, or 128 bytes), while the data stored into at least a portion of the memory space 171 is stored persistently in the storage spaces (e.g., 201, 203) of the memory sub-systems 161, . . . , 163. The host devices (e.g., 118, 128, 129) can be relieved from operations to enter commands in submission queues (e.g., 181, 185) configured for the memory sub-system 161, . . . , 163. At least a portion of the random access memory of the memory devices 141, 143, . . . , 145 can be used dynamically by the controller 122 as the cache memory for access in the storage spaces 201, . . . , 203 of the memory sub-systems 161, . . . , 163, without the host devices (e.g., 118, 128, 129) performing operations to manage or effectuate the caching.

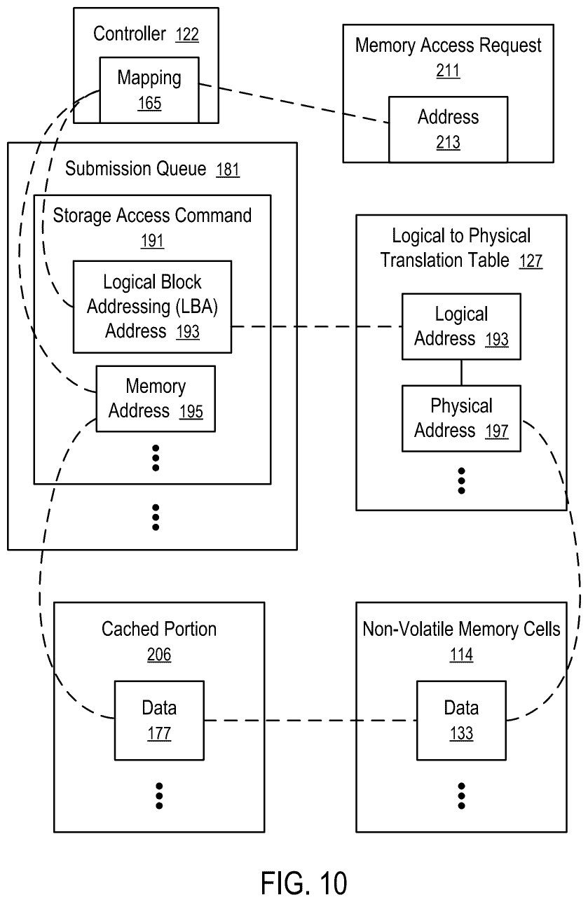

FIG. 10 illustrates communications to implement a memory access request according to one embodiment. For example, when a device (e.g., 118, 128, 129) sends a memory access request 211 into the computer express link (CXL) fabric 121 in FIG. 9 to access a location in the memory space 171 that is mapped to a location in a storage space 201 in the memory sub-system 161, the memory access request 211 can be processed in a way as illustrated in FIG. 10.

In FIG. 10, when a memory access request 211 is received in the computer express link (CXL) fabric 121, the controller 122 uses its mapping 165 to determine how to route the memory access request 211 to a memory device (e.g., 141, 143, or 145) that is connected to the fabric to provide a random access memory.

Based on the mapping 165, the controller 122 can determine that the address 213 is in a portion of the mapped memory space 171 that is configured as a cached portion 206 of the storage space 201 provided by non-volatile memory cells 114 in a memory sub-system 161. Alternatively, or in combination, the controller 122 can determine that the address 213 is in a portion 206 of the mapped memory space 171 that has persistent storage implemented in the storage space 201 provided by non-volatile memory cells 114 in the memory sub-system 161.

In response, the controller 122 can determine whether the cached portion 206 is already implemented using the random access memory of the memory devices 141, 143, . . . , 145 on the fabric 121. If not, the controller can generate a storage access command 191 to implement the caching of the portion of the non-volatile memory cells 114 in the cached portion 206.

For example, the controller 122 can allocate a portion of the random access memory of the memory devices 141, 143, . . . , 145 as the cached portion 206 identified by a memory address 195 in the mapped memory space 171 such that memory access requests addressing the memory address 195 is routed to one of the memory devices 141, 143, . . . , 145 over the fabric 121. Further, based on the mapping 165, the controller 122 can determine the logical block addressing (LBA) address 193 for retrieving data 177 from the non-volatile memory cell 114 to the cached portion 206 in a way as illustrated in FIG. 8. After the memory sub-system 161 executes the storage access command 191, the controller 122 can route the memory access request 211 over the fabric 121 to a memory device (e.g., 141, 143, . . . , or 145) according to the mapping 165 from the memory address 195 to the address in the memory device (e.g., 141, 143, . . . , or 145) used to implement the cached portion 206.

Subsequently, when the controller 122 determines that the cached portion 206 is not going to be accessed for a period of time, the controller 122 can enter a write command in the submission queue 181 to write the data 177 in the cached portion 206 into the memory sub-system 161 at the logical block addressing (LBA) address 193, as in FIG. 8. Thus, the data of the cached portion 206 has persistent storage in the non-volatile memory cells 114 in the memory sub-system 161.

In some implementations, a buffer manager 113 is configured in the controller 122 of the computer express link (CXL) fabric 121 to implement the caching of portions of storage spaces 201, . . . , 203 of the memory sub-systems 161, . . . , 163, as discussed above in connection with FIG. 9 and FIG. 10.

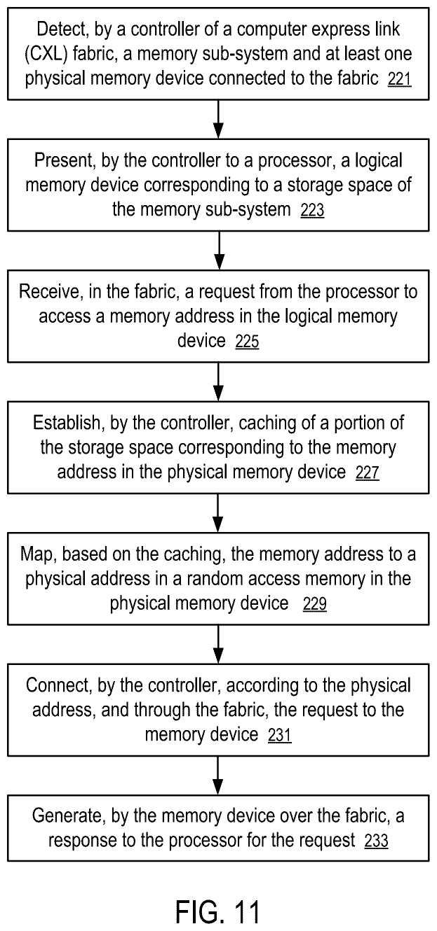

FIG. 11 to FIG. 13 show methods to provide memory access to a storage space of a memory sub-system according to some embodiments. For example, the methods of FIG. 11 to FIG. 13 can be implemented via a buffer manager 113 running in a controller 122 of a computer express link (CXL) fabric 121 as in FIG. 2 to FIG. 10.

In some implementations, a controller 122 of a CXL fabric 121 can present a memory sub-system 161, connected to the CXL fabric 121 and having a storage space 201 to be accessed via LBA addresses and submission queues (e.g., 181), as a logical memory device having a random access memory that is accessible via memory access requests (e.g., 211) that are routed over the fabric 121 to memory devices 141, 143, . . . , 145, as in the method of FIG. 11.

At block 221 in FIG. 11, a controller 122 of a computer express link (CXL) fabric 121 detects a memory sub-system 101 (e.g., 161 or 163) and at least one physical memory device (e.g., 141, 143, . . . , 145) that are connected to the fabric 121.

At block 223, the controller 122 presents, to a processor, a logical memory device corresponding to a storage space (e.g., 201, or 203) of the memory sub-system (e.g., 161, or 163).

For example, at least the persistent storage of data in the logical memory device is implemented by the controller 122 in the storage space (e.g., 201, or 203) of the memory sub-system (e.g., 161, or 163).

For example, the processor can be a central processing unit (CPU) or system on a chip (SoC) (e.g., processing device(s) 118), or an artificial intelligence (AI) accelerator or graphical processing unit (GPU) (e.g., devices 128 or 129), in a host system 102 that contains the CXL fabric 121.

For example, the logical memory device can have memory addresses in a cached portion (e.g., 202 or 204) in a mapped memory space 171 addressable, using memory addresses (e.g., 195), by a device (e.g., 118, 128, 129) connected to the fabric 121. Memory addresses in the mapped memory space 171 are mapped by the controller 122 to random access memories in the at least one physical memory device (e.g., 141, 143, . . . , 145) connected to the fabric 121.

At block 225, the fabric 121 receives a request (e.g., 211) from the processor to access a memory address 213 in the logical memory device.

At block 227, the controller 122 establishes caching, in the physical memory device (e.g., 141, 143, or 145), of a portion of the storage space (e.g., 201, or 203) corresponding to the memory address (e.g., 213), e.g., as in FIG. 10.

At block 229, the controller 122 maps, based on the caching established at block 227, the memory address 213 to a physical address in a random access memory in the physical memory device (e.g., 141, 143, or 145).

For example, the techniques of mapping a portion of a host memory buffer (e.g., 167) to a portion in a memory device (e.g., 141, 143, or 145) in FIG. 5 and FIG. 6 can be used to map a cached portion 206 of the storage space (e.g., 201 or 203) to a portion (e.g., 151 or 155) in a memory device (e.g., 141 or 143).

At block 231, the controller 122 connects, through the fabric 121 and according to the physical address, the request 211 to the memory device (e.g., 141 or 143).

For example, the fabric 121 can include one or more CXL switches and a plurality of point to point CXL connections. The controller 122 can provide instructions to the switches to route the request 211 (e.g., by replacing the address 213 with the physical address in the memory device (e.g., 141 or 143)).

At block 233, the memory device (e.g., 141 or 143) generates, over the fabric 121, a response to the processor for the request 211.

For example, the request 211 can be configured to store or load a unit of data to or from a memory location identified by the address 213. The unit of data can have a size (e.g., one byte, 16 bytes, 128 bytes) that is significantly smaller than a block of data (e.g., 512 bytes or 4 KB) configured to be addressed by a logical block addressing (LBA) address (e.g., 193) used in the memory sub-system (e.g., 161, or 163).

After the cached portion has not been accessed for a period of time, the controller 122 of the computer express link fabric can write the date from the memory device (e.g., 141 or 143) to the memory sub-system (e.g., 161 or 163) and free the random access memory previously allocated to implement the cached portion 206 (e.g., 202 or 204).

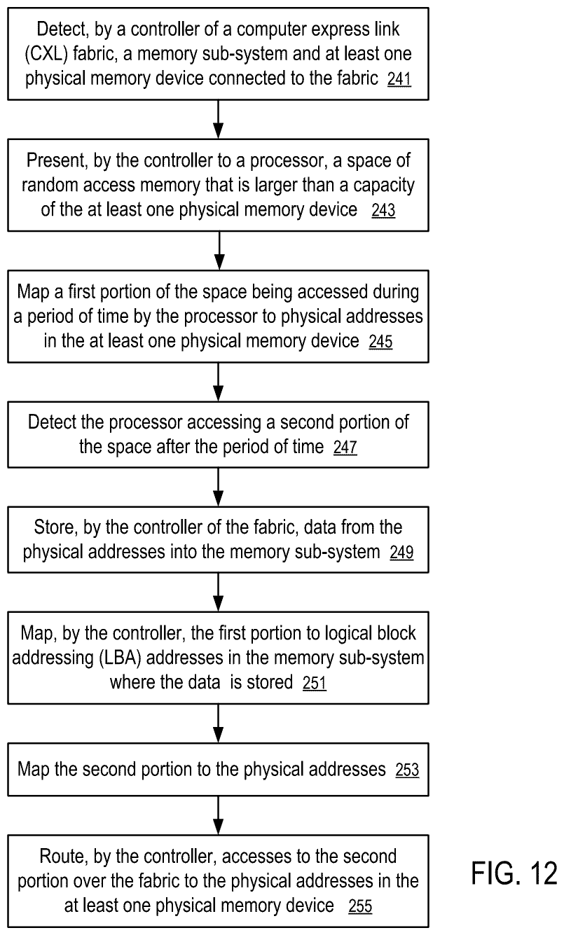

In some implementations, the controller 122 of the CXL fabric 121 can dynamically allocate a portion of random access memory provided by memory devices 141, 143, . . . , 145 on the fabric 121 as the cache memory of an active portion of the storage space (e.g., 201) of a memory sub-system 161 to allow a device (e.g., 118, 128, 129) connected to the CXL fabric 121 to access the storage space via the cache memory addressable using a memory address in the mapped memory space 171, as in FIG. 12. Thus, the mapped memory space 171 can be configured, based on the storage space 201 of the memory sub-system 161, to be larger than the combined memory capacity of the memory devices 141, 143, . . . , 145.

At block 241 in FIG. 12, a controller 122 of a computer express link (CXL) fabric 121 detects a memory sub-system 101 (e.g., 161 or 163) and at least one physical memory device (e.g., 141, 143, . . . , 145) connected to the fabric 121.

At block 243, the controller 122 presents, to a processor (e.g., device 118, 128 or 129), a space 171 of random access memory that is larger than a capacity of the at least one physical memory device (e.g., 141, 143, . . . , 145).

For example, a portion of the mapped memory space 171 can be mapped to the storage space 201 of the memory sub-system 161. However, different sections of the portion of the space 171 mapped to the storage space 201 are not concurrently usable. Instead, one or more sections that correspond to actively in-use portions of the storage space 201 are configured as cached portions (e.g., 202) of the storage space 201 using random access memories allocated from the at least one physical memory device (e.g., 141, 143, . . . , 145). Other sections are not usable until the some of the random access memories of the at least one physical memory device (e.g., 141, 143, . . . , 145) are reallocated to implement the caching of the respective sections of the storage space 201. Thus, a smaller amount of random access memory provided by the at least one physical memory device (e.g., 141, 143, . . . , 145) can be used to implement caching for accessing the storage space 201 a few sections at a time.

At block 245, the controller 122 maps a first portion of the space 171 being accessed during a period of time by the processor (e.g., 118, 128, 129) to physical addresses in the at least one physical memory device (e.g., 141, 143, . . . , 145).

For example, when the host system 102 is actively using the cached portion 202 of the space 171, the controller 122 can implement the cached portion 202 of the space 171 using the random access memory of the memory devices 141, 143, . . . , 145 (e.g., as in FIG. 10).

At block 247, the controller 122 detects the processor (e.g., 118, 128, 129) accessing a second portion of the space 171 after the period of time.

For example, the second portion of the space 171 is currently not mapped to any of the memory devices 141, 143, . . . , 145. To facilitate random access to the second portion of the space 171 using memory access requests, the controller 122 can reuse a portion of the random access memory previously used to implement the cached portion 202. The controller 122 can enter storage access commands (e.g., write commands) in the submission queue (e.g., 181) configured for the memory sub-system 161 to store the data from the cached portion 202 into the storage space 201 of the memory sub-system 161, and enter further storage access commands (e.g., read commands) to retrieve the data corresponding to the second portion of the space 171 from the storage space 201 of the memory sub-system 161 into the reused portion of the random access memory that is now mapped to the second portion of the space 171. Memory access requests addressing the second portion of the space 171 are then routed via the CXL fabric 121 to the reused portion of the random access memory of the memory devices 141, 143, . . . , 145.

At block 249, the controller 122 of the fabric 121 stores data (e.g., 177) from the physical addresses into the memory sub-system (e.g., 161).

For example, the controller 122 can enter a write command (e.g., storage access command 191) in the submission queue 181 configured for the memory sub-system 161 to write the data 177 from the memory address 195 corresponding to the physical addresses in the physical memory devices 141, 143, . . . , 145 to one or more LBA addresses (e.g., 193) in the memory sub-system 161. After the execution of the write command, the random access memory previously used to implement the cached portion 202 can be freed and reused to implement the second portion of the space 171 that is being accessed by the processor (e.g., 118, 128, 129).

At block 251, the controller 122 maps the first portion (e.g., cached portion 202) to logical block addressing (LBA) addresses (e.g., 193) in the memory sub-system (e.g., 161) where the data is stored.

For example, if subsequently, the processor (e.g., device 118, 128, or 129) is to access the first portion (e.g., cached portion 202), the controller 122 can again allocate a portion of the random access memory of the memory devices 141, 143, . . . , 145 to implement the first portion (e.g., cached portion 202) and send a read command to the memory sub-system (e.g., 161) to retrieve the data from the LBA addresses (e.g., 193) to the first portion (e.g., cached portion 202). The portion of the random access memory of the memory devices 141, 143, . . . , 145 allocated to re-implement the first portion (e.g., cached portion 202) can be the same portion used to implement the first portion previously, or a different portion.

At block 253, the controller 122 maps the second portion to the physical addresses of the at least one physical memory device (e.g., 141, 143, . . . , 145). Thus, the random access memory at the physical addresses of the at least one physical memory device (e.g., 141, 143, . . . , 145), previously used to implement the first portion (e.g., cached portion 202), is reused to implement the second portion.

Alternatively, a different portion of the random access memory in the at least one physical memory device (e.g., 141, 143, . . . , 145) can be allocated to implement the second portion of the space 171.

At block 255, the controller 122 routes accesses to the second portion over the fabric 121 to the physical addresses in the at least one physical memory device (e.g., 141, 143, . . . , 145).

For example, the controller 122 can use the submission queue 181 configured for the memory sub-system 161 to retrieve data from the corresponding portion of the storage space 201 into the second portion of the space 171 to facilitate the requests to load data from memory addresses in the second portion of the space 171.

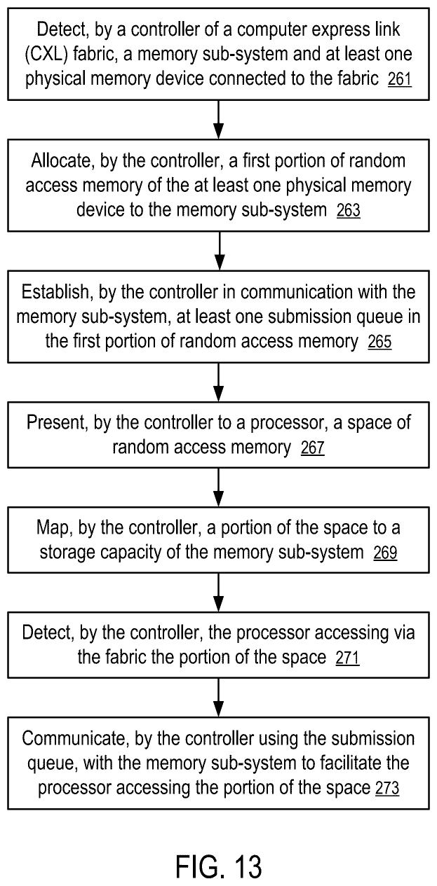

In some implementations, the controller 122 of the CXL fabric 121 can dynamically allocate a portion of random access memory provided by memory devices 141, 143, . . . , 145 on the fabric 121 (e.g., memory 173) as cyclic buffers for message queues (e.g., submission queue 181 and completion queue 183) to communicate with the memory sub-system 161 in implementing the mapped memory space 171, as in FIG. 13. The cyclic buffers (e.g., submission queue 181 and completion queue 183) are reserved from communications between the controller 122 and the memory sub-system 161. When the cyclic buffers are not in use, the random access memory allocated to implement the cyclic buffers can be reused for implementing other portions (e.g., 202 or 204) of the mapped memory space 171. Thus, the controller 122 can use the mapping 165 to pool the random access memories of the memory devices 141, 143, . . . , 145 together to dynamically meet the memory access demands through the CXL fabric 121.

Optionally, the message queues (e.g., submission queue 181 and completion queue 183) can be configured for sharing between the memory sub-system 161 and the controller 122, but not accessible to other devices (e.g., 118, 128, 129) such that the operations of the memory sub-system 161 is controlled exclusively by the controller 122 (e.g., to implement persistent data storage of the mapped memory space 171).

A portion of the mapped memory space 171 (e.g., memory 173) configured for the memory sub-system 161 can include a host memory buffer 167 for storing at least a portion of logical to physical translation table 127 of the memory sub-system 161. The mapping of portions of the host memory buffer 167 to the portions (e.g., 151, 155) in the memory devices 141, 143, . . . , 145 can be implemented dynamically in response to the usages of the logical to physical translation table 127. Thus, the controller 122 can allocate a large portion of the mapped memory space 171 to the memory sub-system 161 as the host memory buffer 167. Further, the controller 122 can implement the persistent storage of the data in the host memory buffer 167 in another memory sub-system 163, in a way similar to the implementation of the persistent storage of data 177 in a storage space (e.g., 201 or 203) in a memory sub-system (e.g., 161 or 163).

At block 261 in FIG. 13, a controller 122 of a computer express link (CXL) fabric 121 detects a memory sub-system 101 (e.g., 161 or 163) and at least one physical memory device (e.g., 141, 143, . . . , 145) connected to the fabric 121.

Based on the resources offered by the memory sub-system 101 (e.g., 161 or 163) and the at least one physical memory device (e.g., 141, 143, . . . , 145), the controller 122 can implement a mapped memory space 171 of random access memory accessible to a processor (e.g., 118, 128, 129) in the host system 102, such as devices 118, 128, . . . , 129.

The mapped memory space 171 of random access memory can be further accessible to the memory sub-system 101 (e.g., 161 or 163) in execution of storage access commands (e.g., 191, such as read commands, write commands configured according to a standard of non-volatile memory express (NVMe)).

At block 263, the controller 122 allocates a first portion of random access memory of the at least one physical memory device 141, 143, . . . , 145 to the memory sub-system (e.g., 161).

For example, the first portion of random access memory of the at least one physical memory device 141, 143, . . . , 145 can be allocated to implement memory 173 in the mapped memory space 171.

At block 265, the controller 122 establishes, in communication with the memory sub-system 161 (e.g., during a boot up time of the memory sub-system 161), at least one submission queue 181 in the first portion of random access memory (e.g., mapped to the memory 173 in the memory space 171).

At block 267, the controller 122 presents, to a processor, a space 171 of random access memory.

In some implementations, the space 171 can include the memory 173 and configured to allow the processor (e.g., device 118, 128, or 129) to access at least a portion of the memory 173 (e.g., the submission queue 181 and the completion queue 183).

In other implementations, the space 171 of random access memory presented to the processor (e.g., as a logical memory device) is configured to exclude the memory 173 that is reserved for exclusive use by the controller 122 and the memory sub-system 161. For example, the memory 173 can be configured in a logical memory device that is not visible the processor (e.g., 118, 128, 129).

At block 269, the controller 122 maps a portion of the space 171 (e.g., presented to the processor as a logical memory device having a random access memory) to a storage capacity or space 201 of the memory sub-system 161.

At block 271, the controller 122 detects the processor accessing via the fabric 121 the portion of the space 171.

At block 273, the controller 122 communicates, using the submission queue 181, with the memory sub-system 161 to facilitate the processor accessing the portion of the space 171.

For example, the controller 122 can remap the portion of the space 171 to a second portion of random access memory of the at least one physical memory device 141, 143, . . . , 145, and load data from the portion of the storage capacity or space 201 of the memory sub-system 161 to the second portion of random access memory of the at least one physical memory device 141, 143, . . . , 145.

For example, after the controller 122 determines that the portion of the portion of the space 171 is not in active use, the controller 122 can issue a write command to the memory sub-system 161 to store the data from the portion of the space 171 into the storage space 201 of the memory sub-system 161 and free the second portion of random access memory of the at least one physical memory device 141, 143, . . . , 145 for other uses.

The techniques of dynamically implementing a portion of the mapped memory space 171 using a portion of random access memories of the memory devices 141, 143, . . . , 145 can also be used in the implementations of portions of the memory 173 allocated to the memory sub-system 161, such as a portion of the host memory buffer 167, the submission queue 181, and/or the completion queue 183. Thus, based on the current patterns of usages of the mapped memory space 171 and/or the communication traffic in the CXL fabric 121, the controller 122 can adjust its mapping 165 to maximize the system performance and utilization of the memory devices 141, 143, . . . , 145.

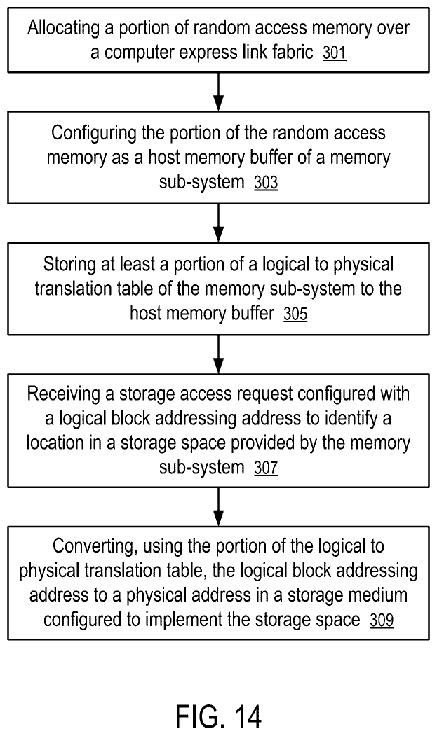

FIG. 14 shows a method to implement a disaggregated host memory buffer via random access memory connected via a computer express link fabric according to one embodiment. For example, the method of FIG. 14 can be implemented in the computing system 100 of FIG. 1 using the techniques discussed above in connection with FIG. 2 to FIG. 13.

For example, the computing system (e.g., 100 of FIG. 1) can have a computer express link fabric 121, a random access memory 112 provided by a plurality of memory devices (e.g., 123; 141, 143, . . . , 145) having random access memory cells, a memory bus 109, a main memory 124, at least one processing device 118 connected to the main memory 124 via the memory bus 109 and connected to the computer express link fabric 121, a peripheral bus 107, and a plurality of memory sub-systems (e.g., 101; 161, . . . , 163) connected to the at least one processing device via the peripheral bus 107. Each of the plurality of memory devices (e.g., 123; 141, 143, . . . , 145) is connected to the computer express link fabric 121 via a separate computer express link connection. The processing device(s) is a central processing unit, or cores of a central processing unit, or a system on a chip.

In the computing system 100, a plurality of portions of the random access memory cells in the plurality of memory devices (e.g., 123; 141, 143, . . . , 145) can be allocated respectively as a plurality of host memory buffers (e.g., 167, . . . , 169) for the plurality of memory sub-systems (e.g., 161, . . . , 163). Each of the host memory buffers (e.g., 167, . . . , 169) is allocated for exclusive use by one of the plurality of memory sub-systems (e.g., 161, . . . , 163).

For example, a first host memory buffer (e.g., 167), among the host memory buffers (e.g., 167, . . . , 169), includes portions (e.g., 151, 155) of random access memory cells allocated from more than one of the plurality of memory devices. Thus, the first host memory buffer (e.g., 167) can be physically disaggregated across multiple memory devices (e.g., 141, 143) that have separate computer express link connects to the fabric 121.

For example, the computer express link fabric 121 can be configured to map memory addresses in the first host memory buffer 167 to physical memory addresses of random access memory cells in the more than one of the plurality of memory devices (e.g., 141, 143).

For example, the computer express link fabric 121 can have a plurality of computer express link switches and a plurality of computer express link connections among the switches. The computer express link fabric 121 can include controller 122 that is configured to monitor memory access traffic going through the computer express link fabric 121 and adjust, based on the memory access traffic, mapping from the memory addresses in the first host memory buffer 167 to physical memory addresses of random access memory cells in the plurality of memory devices (e.g., 141, 143). The adjustment can be performed without restarting of any of the memory sub-systems 161, . . . , 163.

For example, each of the plurality of memory sub-systems 161, . . . , 163 is configured with a flash translation layer having a logical to physical translation table (e.g., 127) and configured to store at least a portion of the logical to physical translation table (e.g., 127) in one of the host memory buffers (e.g., 125; 167, or 169) allocated to the respective memory sub-system (e.g., 101; 161, or 163).

At block 301, the method of FIG. 14 includes allocating a portion of random access memory 112 over a computer express link fabric 121.

For example, the random access memory 112 is configured in a plurality of memory devices (e.g., 123; 141, 143, . . . , 145) connected to the computer express link fabric 121.

At block 303, the method includes configuring the portion of the random access memory 112 as a host memory buffer 125 of a memory sub-system 101.

For example, the host memory buffer 125 includes a plurality of portions (e.g., 151, 155) configured respectively in the plurality of memory devices (e.g., 141, 143).

At block 305, the method includes storing at least a portion of a logical to physical translation table 127 of the memory sub-system 101 to the host memory buffer 125.

At block 307, the method includes receiving a storage access request (e.g., command 191) configured with a logical block addressing address 193 to identify a location in a storage space provided by the memory sub-system 101 (e.g., a physical address of a set of non-volatile memory cells 114).

At block 309, the method includes converting, using the portion of the logical to physical translation table 127 in the host memory buffer 125, the logical block addressing address 193 to a physical address 197 in a storage medium (e.g., non-volatile memory cells 114) configured to implement the storage space.

For example, locations in the host memory buffer (e.g., 125 or 167) ca be addressable by the memory sub-system (e.g., 101 or 161) using memory addresses in a mapped memory space 171. The method of FIG. 14 can further include: mapping the memory addresses (e.g., 195) identified in memory access requests, received in the computer express link fabric 121, to physical memory addresses in the plurality of memory devices (e.g., 123; 141, 143, . . . , 145); and routing the memory access requests through the computer express link fabric 121 based on the mapping. For example, the memory access requests can be from the memory sub-system 101 to access the host memory buffer 125 (e.g., to buffer a portion of the logical to physical translation table 127, to perform a lookup of a physical address 197 corresponding to a logical address 193, etc.). For example, the method of FIG. 14 can further include: changing the mapping based at least in part on traffic patterns in the computer express link fabric 121; and the mapping can be changed without restarting any of the memory sub-systems (e.g., 161, . . . , 163) connected to the fabric 121.

For example, the storage access request (e.g., command 191) can include an opcode for a write operation; and the method of FIG. 14 can further include: updating the portion of the logical to physical translation table 127 in the host memory buffer (e.g., 125 or 167) in response to execution of the write operation.

For example, the storage access request (e.g., command 191) include an opcode for a read operation; and the method of FIG. 14 can further include: determining a memory location in the host memory buffer (e.g., 125 or 167) based on the logical block addressing address 193; transmitting into the computer express link fabric 121 a memory address request to load the physical address 197 from the memory location; and performing the read operation using the physical address 197.

For example, the memory sub-system 101 or 161 can have a host interface 108 configured to operate on a computer bus 107; non-volatile memory cells 114 configured to provide a persistent storage space 201 addressable over the host interface 108 via logical block addressing addresses (e.g., 193). The memory sub-system 101 or 161 can further include at least one processing device 117 configured (e.g., via firmware) to: process storage access requests (e.g., command 191) received over the host interface 108; allocate a portion of random access memory 112 over the host interface 108 and a computer express link fabric 121; buffer at least a portion of a logical to physical translation table 127 in the portion of random access memory 112; and convert, using the portion of the logical to physical translation table 127 buffered in the portion of the random access memory 112, the logical block addressing addresses (e.g., 193) to physical addresses (e.g., 197) of the non-volatile memory cells 114 in processing of the storage access requests (e.g., command 191). For example, the at least one processing device 117 can be configured (e.g., via firmware) to operate the portion of the random access memory 112 as a host memory buffer (e.g., 125 or 167).

For example, the non-volatile memory cells 114 can be NAND memory cells configured to be written to in the memory sub-system 101 at minimum of one page at a time, and to be erased in the memory sub-system at minimum of one block of predetermined number of pages at a time. The memory sub-system 101 cannot erase some of the pages in the block without erasing other pages in the block.

For example, the random access memory 112 is volatile (e.g., DRAM or SRAM); and the at least one processing device 117 can be further configured to maintain, in the non-volatile memory cells 114, a persistent copy of the logical to physical translation table 127 as metadata 131.

For example, the computer bus 107 can be a peripheral component interconnect express (PCIe) bus; and the memory sub-system (e.g., 101 or 161) can further include: a local memory 119; and a direct memory access engine 135 configured to copy the portion of the logical to physical translation table 127 between the local memory and the portion of the random access memory 112 allocated from the more than one of the plurality of memory devices (e.g., 123; 141, 143, . . . , 145).

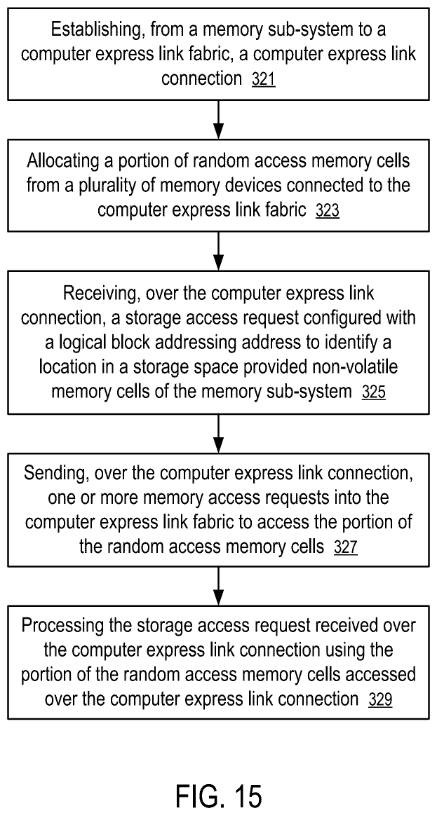

FIG. 15 shows a method to implement storage services via a memory sub-system having a computer express link connection to access random access memory cells connected via a computer express link fabric according to one embodiment. For example, the method of FIG. 15 can be implemented in the computing system 100 of FIG. 1 using the techniques discussed above in connection with FIG. 2 to FIG. 13.

For example, the computing system (e.g., 100) can include: a computer express link fabric 121; a plurality of memory devices (e.g., 123; 141, 143, . . . , 145) having random access memory cells to provide a random access memory 112; and a memory sub-system (e.g., 101, 161, or 163) having non-volatile memory cells 114 to provide a storage space (e.g., 201 or 203). For example, each of the plurality of memory devices (e.g., 123; 141, 143, . . . , 145) and the memory sub-system (e.g., 101, 161, or 163) is connected to the computer express link fabric 121 via a separate computer express link connection.

For example, the memory sub-system (e.g., 101, 161 or 163) can be configured to use a portion of the random access memory cells, in the plurality of memory devices (e.g., 123; 141, 143, . . . , 145) but outside of the memory sub-system (e.g., 101, 161 or 163), in processing a storage access request (e.g., command 191) received via the computer express link fabric 121.

For example, the storage access request (e.g., command 191) can include a logical block addressing address 193 to identify a subset of the non-volatile memory cells 114; and the memory sub-system (e.g., 101, 161, or 163) is configured to translate the logical block addressing address 193 to a physical address 197 of the subset of the non-volatile memory cells 114 using a portion of logical to physical translation table 127 stored in the portion of the random access memory cells.

For example, the portion of the logical to physical translation table 127 in the random access memory cells can be allocated from more than one of the plurality of memory devices (e.g., 123; 141, 143, . . . , 145).

For example, the computer express link fabric 121 can be configured to map memory addresses provided by memory access requests entering the computer express link fabric 121 to physical addresses of respective random access memory cells in the plurality of memory devices (e.g., 123; 141, 143, . . . , 145). The computer express link fabric 121 can include a plurality of computer express link switches, and a controller 122 is configured to: monitor memory access traffic going through the computer express link fabric 121; and dynamically adjust, based on the memory access traffic, mapping from memory addresses provided by memory access requests entering the computer express link fabric 121 to physical addresses of respective random access memory cells in the plurality of memory devices (e.g., 123; 141, 143, . . . , 145) to reduce latency of requests propagating through the fabric 121.

For example, a submission queue (e.g., 181 or 185) can be configured in a subset of the random access memory cells in the random access memory 112; and the memory sub-system (e.g., 101, 161, or 163) can be configured to retrieve the storage access request (e.g., command 191) from the submission queue (e.g., 181 or 185).

At block 321, the method of FIG. 15 includes establishing, from a memory sub-system (e.g., 101, 161 or 163) to a computer express link fabric 121, a computer express link connection (e.g., 107 as in FIG. 4).

For example, the memory sub-system (e.g., 101, 161 or 163) can have a host interface 108 configured to operate on a computer express link connection (e.g., as in FIG. 4). The memory sub-system (e.g., 101, 161 or 163) can have non-volatile memory cells 114 configured to provide a persistent storage space addressable over the host interface 108 via logical block addressing addresses (e.g., 193). The memory sub-system (e.g., 101, 161 or 163) can include at least one processing device 117 configured via firmware to implement a buffer manager 113 to perform the operations discussed in connection with host memory buffers 125, 167, and 169 and/or to perform other operations of the memory sub-system (e.g., 101, 161 or 163).

For example, the non-volatile memory cells 114 in the memory sub-system 101, 161 or 163 can be NAND memory cells configured to be written to in the memory sub-system at minimum of one page at a time, and to be erased in the memory sub-system at minimum of one block of predetermined number of pages at a time. A block is a smallest unit to erase the NAND memory cells to store data in the memory sub-system 101, 161, or 163; and thus, an erasure operation cannot be performed in the memory sub-system 101, 161, or 163 to erase some of the pages in a block without easing the other pages in the block. A NAND memory cell is to be in an erased state in order to be programmed to store data. A page is a smallest unit to program memory cells to store data in the memory sub-system 101, 161, or 163; and thus, a data programming operation cannot be performed to program some memory cells in a page without programming other memory cells in the page.

At block 323, the method includes allocating a portion of random access memory cells (e.g., memory 173 or 175, host memory buffer 167 or 169) from a plurality of memory devices (e.g., 123; 141, 143, . . . , 145) connected to the computer express link fabric 121.

For example, the at least one processing device 117 of the memory sub-system 101, 161 or 163 can be configured to cache or buffer, in the portion of the random access memory cells (e.g., memory 173 or 175), and a portion of data (e.g., metadata 131 and/or user data 133) stored in the non-volatile memory cells 114.

For example, the portion of the data cached or buffered in the random access memory 112 allocated over the computer express link fabric 121 can include metadata 131, such as a portion of a logical to physical translation table 127 of a flash translation layer of the memory sub-system 101, 161, or 163.

At block 325, the method includes receiving, over the computer express link connection (e.g., 107 in FIG. 4), a storage access request (e.g., command 191) configured with a logical block addressing address 193 to identify a location in a storage space (e.g., 201 or 203) provided non-volatile memory cells (e.g., 114) of the memory sub-system (e.g., 101, 161, or 163).

At block 327, the method includes sending, over the computer express link connection (e.g., 107 in FIG. 4), one or more memory access requests into the computer express link fabric 121 to access the portion of the random access memory cells (e.g., memory 173 or 175, host memory buffer 167 or 169).

At block 329, the method includes processing the storage access request (e.g., command 191) received over the computer express link connection (e.g., 107 in FIG. 4) using the portion of the random access memory cells (e.g., memory 173 or 175, host memory buffer 167 or 169) accessed over the computer express link connection.

For example, the portion of the random access memory cells (e.g., memory 173 or 175, host memory buffer 167 or 169) can be allocated from more than one of the plurality of memory devices (e.g., 123; 141, 143, . . . , 145) connected to the computer express link fabric 121. Each of the plurality of memory devices (e.g., 123; 141, 143, . . . , 145) is connected via a separate CXL connection to the computer express link fabric 121.

For example, each of the one or more memory access requests can be configured with a memory address in a mapped memory space 171; and the computer express link fabric 121 is configured to map the memory address to an address of a subset of memory cells in one of the plurality of memory devices (e.g., 123; 141, 143, . . . , 145) connected to the computer express link fabric 121.

For example, the method of FIG. 15 can further include: storing at least a portion of a logical to physical translation table 127 of the memory sub-system (e.g., 101, 161, or 163) in the portion of the random access memory cells (e.g., host memory buffer 125, 167 or 169). The storage access request (e.g., command 191) can be processed via loading, from the portion of the logical to physical translation table 127 that is buffered/cached in the portion of the random access memory cells (e.g., host memory buffer 125, 167 or 169), a physical address 197 of non-volatile memory cells 114 (e.g., one or more pages of NAND memory cells) used to implement a storage space identified by the logical block addressing address 193.

For example, the method of FIG. 15 can further include: retrieving, over the computer express link connection (e.g., 107 in FIG. 4), the storage access request (e.g., command 191) from a submission queue (e.g., 181 or 185) configured in the portion of the random access memory cells (e.g., memory 173 or 175).

For example, the storage access request (e.g., command 191) can include an opcode for a write operation; and the method of FIG. 15 can further include: loading, over the computer express link connection (e.g., 107 in FIG. 4) and via memory access requests, data to be written via the write operation from the mapped memory space 171 at a memory address 195 identified in the storage access request (e.g., command 191).

For example, the storage access request (e.g., command 191) can include an opcode for a read operation; and the method of FIG. 15 can further include: storing, over the computer express link connection (e.g., 107 in FIG. 4) and via memory access requests, data retrieved via the read operation into the mapped memory space 171 at a memory address 195 identified in the storage access request (e.g., command 191).

For example, the storage access request (e.g., command 191) can be in accordance with a standard for non-volatile memory express (NVMe); and the one or more memory access requests can be in accordance with a standard for computer express link (CXL).

For example, the random access memory cells allocated over the CXL fabric 121 can be volatile; and the at least one processing device 117 of the memory sub-system 101, 161, or 163 can be further configured to maintain, in the non-volatile memory cells 114, a persistent copy of data cached or buffered in the portion of the random access memory cells allocated over the CXL fabric 121.

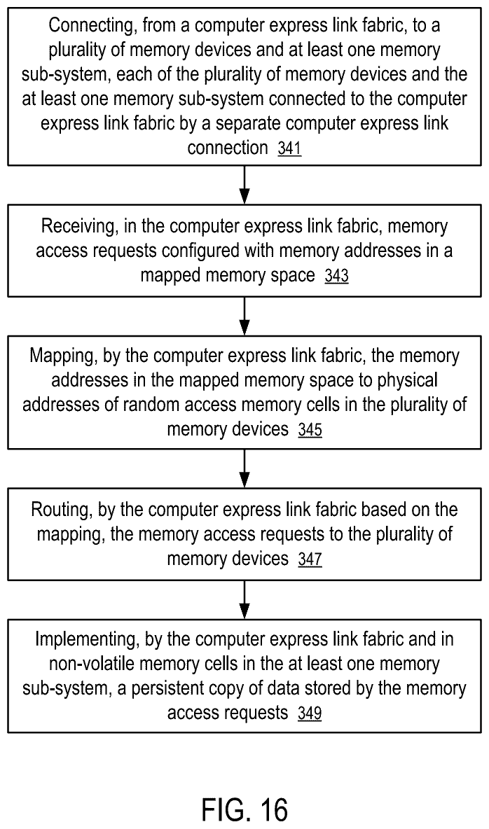

FIG. 16 shows a method to provide unified memory and storage services over computer express link fabric according to one embodiment. For example, the method of FIG. 16 can be implemented in the computing system 100 of FIG. 1 using the techniques discussed above in connection with FIG. 2 to FIG. 13, and optionally in combination with the methods of FIG. 14 and/or FIG. 15.

For example, the computing system 100 can have a computer express link fabric 121 configured to provide a unified memory and storage service using a plurality of memory devices (e.g., 123; 141, 143, . . . , 145) having random access memory cells and one or more memory sub-systems (e.g., 101, 161, 163) having non-volatile memory cells 114. The computer express link fabric 121 can have a plurality of computer express link switches, a plurality of point to point computer express link connections among the computer express link switches; and a controller 122 configured (e.g., via firmware or software) to provide the unified memory and storage service via its mapping 165 to route memory access requests over the fabric 121 to the memory devices (e.g., 123; 141, 143, . . . , 145).

For example, the controller 122 can map memory addresses in a mapped memory space 171 to physical addresses of random access memory cells of memory devices (e.g., 123; 141, 143, . . . , 145) connected to the computer express link fabric 121. The switches in the fabric 121 are configured to route memory access requests based on the mapping 165 implemented by the controller 122. The controller 122 can implement, in a storage space (e.g., 201, 203) of a memory sub-system (e.g., 161, 163) connected to the computer express link fabric 121 and having non-volatile memory cells 114, a persistent copy of data stored by memory access requests received in the computer express link fabric 121 and having memory addresses (e.g., 195) in the mapped memory space 171. Since the mapped memory space 171 is implemented using at least in part the storage space (e.g., 201, 203) of the memory sub-system (e.g., 161, 163), the mapped memory space 171 can be larger than a combined capacity of the random access memory cells of the memory devices (e.g., 123; 141, 143, . . . , 145). For example, the controller 122 can be configured to cache the storage space (e.g., 201 or 203) in the mapped memory space 171 a portion (e.g., 202 or 204) at a time based on memory access requests received in the computer express link fabric 121.

At block 341, the method of FIG. 16 includes connecting, from a computer express link fabric 121, to a plurality of memory devices (e.g., 123; 141, 143, . . . , 145) and at least one memory sub-system (e.g., 101, 161, 163). Each of the plurality of memory devices (e.g., 123; 141, 143, . . . , 145) and the at least one memory sub-system (e.g., 101, 161, 163) is connected to the computer express link fabric 121 by a separate point-to-point computer express link connection.

At block 343, the method includes receiving, in the computer express link fabric 121, memory access requests configured with memory addresses (e.g., 195) in a mapped memory space 171.

At block 345, the method includes mapping, by the computer express link fabric 121, the memory addresses (e.g., 915) in the mapped memory space 171 to physical addresses of random access memory cells in the plurality of memory devices (e.g., 123; 141, 143, . . . , 145).

At block 347, the method includes routing, by the computer express link fabric 121 based on the mapping 165, the memory access requests to the plurality of memory devices (e.g., 123; 141, 143, . . . , 145).

At block 349, the method includes implementing, by the computer express link fabric 121 and in non-volatile memory cells 114 in the at least one memory sub-system (e.g., 101, 161, 163), a persistent copy of data stored by the memory access requests.

For example, the method can further include: monitoring, by the computer express link fabric 121, traffics in the computer express link fabric 121; and adjusting, by the computer express link fabric 121 and based on the monitoring, the mapping 165.

For example, the method can further include: allocating a first portion of the mapped memory space 171 as a host memory buffer (e.g., 167 or 169) of the memory sub-system (e.g., 161 or 163).

For example, the method can further include: allocating a second portion of the mapped memory space 171 as a cyclic buffer to host a submission queue (e.g., 181 or 185) shared between a controller 122 of the computer express link fabric 121 and the memory sub-system (e.g., 161 or 163). For example, the submission queue (e.g., 181 or 185) can be reserved exclusively for the controller 122 to send storage access requests (e.g., command 191) to the memory sub-system (e.g., 101, 161, or 163).

For example, the method can further include: mapping a third portion of the mapped memory space 171 to cache or buffer a portion of a storage space (e.g., 201 or 203) implemented using the non-volatile memory cells 114 in the memory sub-system (e.g., 161 or 163).

For example, the method can further include, in response to a memory access request received in the computer express link fabric 121 and having a memory address in the third portion of the mapping memory space 171: allocating a subset of the random access memory cells in the plurality of memory devices (e.g., 123; 141, 143, . . . , 145); and remapping the third portion to the subset of the random access memory cells in the plurality of memory devices (e.g., 123; 141, 143, . . . , 145).

For example, the remapping can include entering, by the controller 122 of the computer express link fabric 121 and into the submission queue (e.g., 181 or 185), a storage access request (e.g., command 191) containing a read opcode. The completion of processing the storage access request (e.g., command 191) in the memory sub-system (e.g., 101, 161, or 163) causes the data 177 in the cached portion (e.g., 202 or 204) of the storage space (e.g., 201 or 203) of the memory sub-system (e.g., 161 or 163) to be cached or buffered at the memory address 195 identified in the storage access request (e.g., command 191). After the completion of processing the storage access request (e.g., command 191) in the memory sub-system (e.g., 101, 161, or 163), the fabric 121 routes memory address requests addressing the third portion of the mapping memory space 171 to the cached/buffered portion (e.g., 202 or 204) in the random access memory 112 of the memory devices (e.g., 123; 141, 143, . . . , 145).

For example, the subset of the random access memory cells allocated to implement the cached/buffered portion (e.g., 202 or 204) can be previously allocated to implement another portion of the mapped memory space 171. To free up the subset of the random access memory cells, the controller 122 of the computer express link fabric 121 can enter into the submission queue (e.g., 181 or 185), a storage access request containing a write opcode to write data from the subset of the random access memory cells into the non-volatile memory cells 114 in the memory sub-system (e.g., 161 or 163); and then, the controller 122 of the computer express link fabric 121, a fourth portion of the mapped memory space 171, previously implemented using the subset, to the storage space (e.g., 201 or 203) of the memory sub-system (e.g., 161 or 163).

For example, the controller 122 can be configured to dynamically adjust, based on memory access requests received in the computer express link fabric 121, the mapping 165 of the memory addresses in the mapped memory space 171 to the physical addresses of the random access memory cells in the memory devices (e.g., 123; 141, 143, . . . , 145). For example, based on memory access requests received in the computer express link fabric 121, the controller 122 can select a portion of the storage space (e.g., 201 or 203) for caching in the mapped memory space 171.

A non-transitory computer storage medium can be used to store instructions programmed to implement the buffer managers 113 in the host system 102 and the memory sub-system 101. When the instructions are executed by the processing device 118, the controller 115, and the processing device 117, the instructions cause the host system 102 and/or the memory sub-system 101 to perform the methods discussed above.

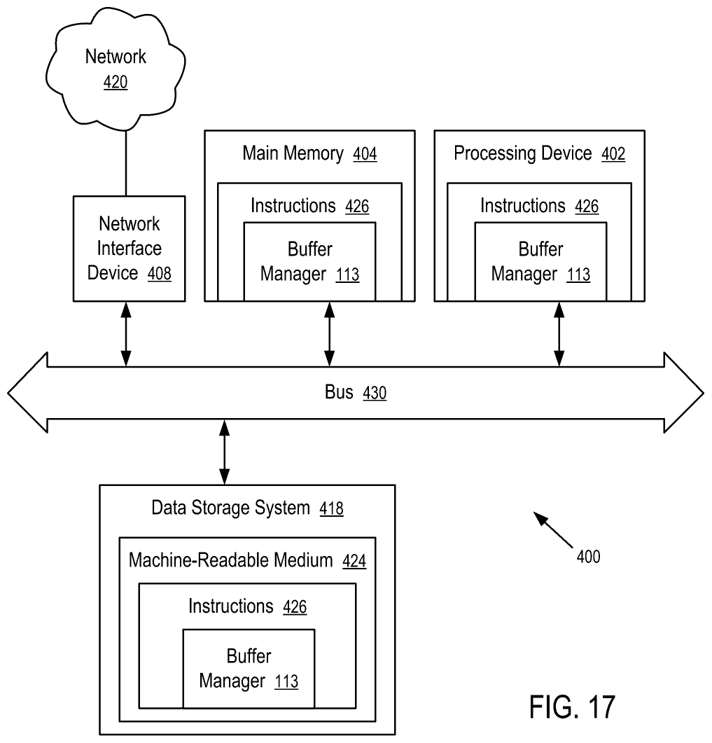

FIG. 17 illustrates an example machine of a computer system 400 within which a set of instructions, for causing the machine to perform any one or more of the methodologies discussed herein, can be executed. In some embodiments, the computer system 400 can correspond to a host system (e.g., the host system 102 of FIG. 1) that includes, is coupled to, or utilizes a memory sub-system (e.g., the memory sub-system 101 of FIG. 1) or can be used to perform the operations of buffer managers 113 (e.g., to execute instructions to perform operations corresponding to the buffer managers 113 described with reference to FIG. 1-16). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a personal digital assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 400 includes a processing device 402, a main memory 404 (e.g., read-only memory (ROM), flash memory, dynamic random access memory (DRAM) such as synchronous DRAM (SDRAM) or Rambus DRAM (RDRAM), static random access memory (SRAM), etc.), and a data storage system 418, which communicate with each other via a bus 430 (which can include multiple buses).

Processing device 402 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 402 can also be one or more special-purpose processing devices such as an application specific integrated circuit (ASIC), a field programmable gate array (FPGA), a digital signal processor (DSP), network processor, or the like. The processing device 402 is configured to execute instructions 426 for performing the operations and steps discussed herein. The computer system 400 can further include a network interface device 408 to communicate over the network 420.

The data storage system 418 can include a machine-readable medium 424 (also known as a computer-readable medium) on which is stored one or more sets of instructions 426 or software embodying any one or more of the methodologies or functions described herein. The instructions 426 can also reside, completely or at least partially, within the main memory 404 and/or within the processing device 402 during execution thereof by the computer system 400, the main memory 404 and the processing device 402 also constituting machine-readable storage media. The machine-readable medium 424, data storage system 418, and/or main memory 404 can correspond to the memory sub-system 101 of FIG. 1.

In one embodiment, the instructions 426 include instructions to implement functionality corresponding to the buffer managers 113 described with reference to FIG. 1-16. While the machine-readable medium 424 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In this description, various functions and operations are described as being performed by or caused by computer instructions to simplify description. However, those skilled in the art will recognize what is meant by such expressions is that the functions result from execution of the computer instructions by one or more controllers or processors, such as a microprocessor. Alternatively, or in combination, the functions and operations can be implemented using special purpose circuitry, with or without software instructions, such as using application-specific integrated circuit (ASIC) or field-programmable gate array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

1. A method, comprising:
establishing, from a memory sub-system to a computer express link fabric, a computer express link connection;
allocating a portion of random access memory cells from a plurality of memory devices connected to the computer express link fabric;
receiving, over the computer express link connection, a storage access request configured with a logical block addressing address to identify a location in a storage space provided by non-volatile memory cells of the memory sub-system;
sending, over the computer express link connection, one or more memory access requests into the computer express link fabric to access the portion of the random access memory cells; and
processing the storage access request received over the computer express link connection using the portion of the random access memory cells accessed over the computer express link connection.

2. The method of claim 1, wherein the portion of the random access memory cells is allocated from more than one of the plurality of memory devices connected to the computer express link fabric, each of the plurality of memory devices connected via a separate connection to the computer express link fabric.

3. The method of claim 2, wherein each of the one or more memory access requests is configured with a memory address in a mapped memory space; and the computer express link fabric is configured to map the memory address to an address of a memory cell in one of the plurality of memory devices connected to the computer express link fabric.

4. The method of claim 3, further comprising:
storing at least a portion of a logical to physical translation table in the portion of the random access memory cells;
wherein the storage access request is processed via loading, from the portion of the logical to physical translation table in the portion of the random access memory cells, a physical address of non-volatile memory cells used to implement a storage space identified by the logical block addressing address.

5. The method of claim 4, further comprising:
retrieving, over the computer express link connection, the storage access request from a submission queue configured in the portion of the random access memory cells.

6. The method of claim 5, wherein the storage access request includes an opcode for a write operation; and the method further comprises:
loading, over the computer express link connection and via memory access requests, data to be written via the write operation from the mapped memory space at a memory address identified in the storage access request.

7. The method of claim 5, wherein the storage access request includes an opcode for a read operation; and the method further comprises:
storing, over the computer express link connection and via memory access requests, data retrieved via the read operation into the mapped memory space at a memory address identified in the storage access request.

8. The method of claim 5, wherein the storage access request is in accordance with a standard for non-volatile memory express; and the one or more memory access requests are in accordance with a standard for computer express link.

9. A system, comprising:
a computer express link fabric;
a plurality of memory devices having random access memory cells; and
a memory sub-system having non-volatile memory cells to provide a storage space, wherein each of the plurality of memory devices and the memory sub-system is connected to the computer express link fabric via a separate connection;
wherein the memory sub-system is configured to use a portion of the random access memory cells, in the plurality of memory devices but outside of the memory sub-system, in processing a storage access request received via the computer express link fabric.

10. The system of claim 9, wherein the storage access request includes a logical block addressing address to identify a subset of the non-volatile memory cells; and the memory sub-system is configured to translate the logical block addressing address to a physical address of the subset of the non-volatile memory cells using a portion of logical to physical translation table stored in the portion of the random access memory cells.

11. The system of claim 10, wherein the portion of the logical to physical translation table in the random access memory cells is allocated from more than one of the plurality of memory devices.

12. The system of claim 11, wherein the computer express link fabric is configured to map memory addresses provided by memory access requests entering the computer express link fabric to physical addresses of respective random access memory cells in the plurality of memory devices.

13. The system of claim 12, wherein the computer express link fabric includes a plurality of computer express link switches.

14. The system of claim 13, wherein the computer express link fabric is configured to:
monitor memory access traffic going through the computer express link fabric; and
adjust, based on the memory access traffic, mapping from memory addresses provided by memory access requests entering the computer express link fabric to physical addresses of respective random access memory cells in the plurality of memory devices.

15. The system of claim 14, wherein the memory sub-system is configured to retrieve the storage access request from a subset of the portion of the random access memory cells.

16. A memory sub-system, comprising:
a host interface configured to operate on a computer express link connection;
non-volatile memory cells configured to provide a persistent storage space addressable over the host interface via logical block addressing addresses; and
at least one processing device configured to:
retrieve a storage access request via the host interface and over the computer express link connection to a computer express link fabric;
allocate a portion of random access memory cells connected to the memory sub-system via the computer express link fabric;
send, via the host interface and over the computer express link connection, one or more memory access requests into the computer express link fabric to access the portion of the random access memory cells; and
process the storage access request based on one or more responses to the one or more memory access requests.

17. The memory sub-system of claim 16, wherein the portion of the random access memory cells is allocated from more than one of a plurality of memory devices, connected to the computer express link fabric, configured outside of the memory sub-system, each of the plurality of memory devices connected to the computer express link fabric via a computer express link connection.

18. The memory sub-system of claim 17, wherein the at least one processing device is further configured to cache, in the portion of the random access memory cells, a portion of data stored in the non-volatile memory cells.

19. The memory sub-system of claim 18, wherein the portion of the data stored in the non-volatile memory cells and cached in the portion of the random access memory cells includes metadata, including at least a portion of a logical to physical translation table of a flash translation layer of the memory sub-system.

20. The memory sub-system of claim 18, wherein the random access memory cells are volatile;
wherein the at least one processing device is further configured to maintain, in the non-volatile memory cells, a persistent copy of data cached in the portion of the random access memory cells; and
wherein the non-volatile memory cells are NAND memory cells configured to be written to in the memory sub-system at minimum of one page at a time, and to be erased in the memory sub-system at minimum of one block of predetermined number of pages at a time.
